(19) United States
(12) Patent Application Publication
(10) Pub. No.: US 2026/0343245 A1
(43) Pub. Date: Oct. 29, 2026

(54) OPPORTUNISTIC RX BEAM ALIGNMENT FOR SIDELINK OPERATION IN FR2

(71) Applicant: Nokia Technologies Oy, Espoo (FI)

(72) Inventors: Nuno Manuel KIILERICH PRATAS, Aalborg (DK); Thomas Haaning JACOBSEN, Aalborg (DK); Stepan KUCERA, Munich (DE); Yong LIU, Shanghai (CN); Renato Barbosa ABREU, Aalborg (DK); Daniel MEDINA, Munich (DE); Torsten WILDSCHEK, Gloucester (GB)

(21) Appl. No.: 19/114,214

(22) PCT Filed: Oct. 8, 2022
(86) PCT No.: PCT/CN2022/123904

§ 371 Date: Mar. 21, 2025

(51) Int. Cl. H04W 16/28

(52) U.S. Cl. CPC H04W 16/28

(57) ABSTRACT

An apparatus configured to: determine to perform an opportunistic reception beam alignment procedure; receive, from a first user equipment, an indication of a type of beamforming the first user equipment applies; determine to use at least one transmission of the first user equipment for the opportunistic reception beam alignment procedure based, at least partially, on one or more predefined conditions; perform the opportunistic reception beam alignment procedure based on at least part of a transmission of the first user equipment intended for, at least, at least one second user equipment; and transmit, to the first user equipment, an indication that a valid reception beam is determined with respect to the first user equipment, wherein the valid reception beam is determined as a result of the opportunistic reception beam alignment procedure.

### TECHNICAL FIELD

The example and non-limiting embodiments relate generally to sidelink (SL) communication and, more particularly, to SL resource alignment.

### BACKGROUND

It is known, with respect to Uu resources, to perform a Uu beam alignment procedure.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: determine to perform an opportunistic reception beam alignment procedure; receive, from a first user equipment, an indication of a type of beamforming the first user equipment applies; determine to use at least one transmission of the first user equipment for the opportunistic reception beam alignment procedure based, at least partially, on one or more predefined conditions; perform the opportunistic reception beam alignment procedure based on at least part of a transmission of the first user equipment intended for, at least, at least one second user equipment; and transmit, to the first user equipment, an indication that a valid reception beam is determined with respect to the first user equipment, wherein the valid reception beam is determined as a result of the opportunistic reception beam alignment procedure.

In accordance with one aspect, a method comprising: determining, with a user equipment, to perform an opportunistic reception beam alignment procedure; receiving, from a first user equipment, an indication of a type of beamforming the first user equipment applies; determining to use at least one transmission of the first user equipment for the opportunistic reception beam alignment procedure based, at least partially, on one or more predefined conditions; performing the opportunistic reception beam alignment procedure based on at least part of a transmission of the first user equipment intended for, at least, at least one second user equipment; and transmitting, to the first user equipment, an indication that a valid reception beam is determined with respect to the first user equipment, wherein the valid reception beam is determined as a result of the opportunistic reception beam alignment procedure.

In accordance with one aspect, an apparatus comprising means for performing: determining to perform an opportunistic reception beam alignment procedure; receiving, from a first user equipment, an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of a transmission of the first user equipment intended for, at least, at least one second user equipment; and transmitting, to the first user equipment, an indication that a valid reception beam is determined with respect to the first user equipment, wherein the valid reception beam is determined as a result of the opportunistic reception beam alignment procedure.

In accordance with one aspect, a non-transitory computer-readable medium comprising program instructions stored thereon for performing at least the following: determining to perform an opportunistic reception beam alignment procedure; causing receiving, from a first user equipment, of an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of a transmission of the first user equipment intended for, at least, at least one second user equipment; and causing transmitting, to the first user equipment, of an indication that a valid reception beam is determined with respect to the first user equipment, wherein the valid reception beam is determined as a result of the opportunistic reception beam alignment procedure.

In accordance with one aspect, an apparatus comprising: at least one processor; and at least one memory storing instructions that, when executed by the at least one processor, cause the apparatus at least to: determine to perform an opportunistic reception beam alignment procedure; transmit, to a first user equipment, an indication of a type of beamforming; transmit, to the first user equipment, at least one transmission based on the indicated type of beamforming; and receive, from the first user equipment, an indication of a valid reception beam determined as a result of the opportunistic reception beam alignment procedure.

In accordance with one aspect, a method comprising: determining, with a user equipment, to perform an opportunistic reception beam alignment procedure; transmitting, to a first user equipment, an indication of a type of beamforming; transmitting, to the first user equipment, at least one transmission based on the indicated type of beamforming; and receiving, from the first user equipment, an indication of a valid reception beam determined as a result of the opportunistic reception beam alignment procedure.

In accordance with one aspect, an apparatus comprising means for performing: determining to perform an opportunistic reception beam alignment procedure; transmitting, to a first user equipment, an indication of a type of beamforming; transmitting, to the first user equipment, at least one transmission based on the indicated type of beamforming; and receiving, from the first user equipment, an indication of a valid reception beam determined as a result of the opportunistic reception beam alignment procedure.

In accordance with one aspect, a non-transitory computer-readable medium comprising program instructions least stored thereon for performing at the following: determining to perform an opportunistic reception beam alignment procedure; causing transmitting, to a first user equipment, of an indication of a type of beamforming; causing transmitting, to the first user equipment, of at least one transmission based on the indicated type of beamforming; and causing receiving, from the first user equipment, of an indication of a valid reception beam determined as a result of the opportunistic reception beam alignment procedure.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a table illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10a is a diagram illustrating features as described herein;

FIG. 10b is a diagram illustrating features as described herein;

FIG. 11 is a flowchart illustrating steps as described herein; and

FIG. 12 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AGC automatic gain control
AMF access and mobility management function
BARS beam alignment reference sequence
BMRS beam management reference signal
BSM basic safety message
CAM co-operative awareness message
CBR channel busy ratio
CRAN cloud radio access network
CSI-RS channel state information reference signal
CU central unit
D2D device-to-device
DU distributed unit
DMRS demodulation reference signal
DRX discontinuous reception
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IoT Internet of Things
ITS intelligent transport system
L1 layer 1
LTE long term evolution
MAC medium access control
MCS modulation and coding scheme
MME mobility management entity
ng or NG new generation
ng-eNB or NG-eNB new generation eNB
NR new radio
N/W or NW network
O-RAN open radio access network
PDCP packet data convergence protocol
PHY physical layer
PRACH physical random access channel
ProSe proximity service
PSCCH physical sidelink control channel
PSFCH physical sidelink feedback channel
PSSCH physical sidelink shared channel
PRB physical resource block
QCL quasi co location
RACH random access channel
RAN radio access network
RAR random access response
RF radio frequency
RLC radio link control
RRC radio resource control
RRH remote radio head
RS reference signal
RSRP reference signal received power
RSSI received signal strength indicator
RU radio unit
Rx receiver
SCI sidelink control information
SDAP service data adaptation protocol
SGW serving gateway
SL sidelink
SL-TCI sidelink transmission configuration indicator
SMF session management function
SPS semi-persistent scheduling
SR scheduling request
SSB synchronization signal block
TCI transmission configuration indicator
Tx transmitter
UE user equipment (e.g., a wireless, typically mobile device)
UPF user plane function
V2I vehicle to infrastructure
V2N vehicle to network
V2P vehicle to pedestrian
V2V vehicle-to-vehicle
V2X vehicle-to-everything
VNR virtualized network function

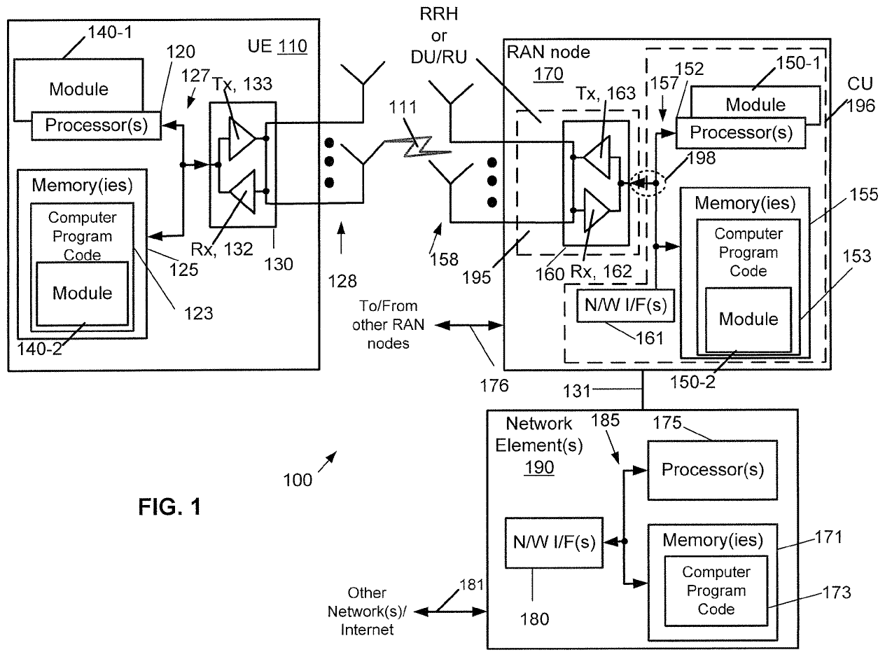

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The UE 110 may be capable of sidelink communication with other UEs in addition to network communication or if wireless communication with a network is unavailable or not possible. For example, the UE 110 may perform sidelink communication with another UE which may include some or all of the features of UE 110, and/or may include additional features. Optionally, the UE 110 may also communicate with other UEs via short range communication technologies, such as Bluetooth®.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUS) (gNB-DUS), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. CRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the equipment 110 can include, but are not limited to, user cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. In addition, various embodiments of the user equipment 110 can include, but are not limited to, devices integrated into vehicles, infrastructure associated with vehicular travel, wearable devices used by pedestrians or other non-vehicular users of roads, user equipment unrelated to traffic users, and user equipment configured to participate in sidelink scenarios, such as public safety user equipment and/or other commercial user equipment.

Having thus introduced one suitable but non-limiting technical context for the practice of the example embodiments of the present disclosure, example embodiments will now be described with greater specificity.

Features as described herein generally relate to sidelink (SL) operation and communication. Example embodiments of the present disclosure may be applicable to sidelink UEs, for example in a scenario in which a network or cell switches off/on for a UE configured to perform sidelink (SL) operations. NR SL methods may be implemented to provide communication between a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may relate to Internet of Things (IoT) and automotive industries (e.g., for reduction of accident risk and safer driving experiences). These use cases may include a message exchange among vehicles (V2V), vehicles and pedestrians (V2P), vehicles and infrastructure (V2I), and/or vehicles and networks (V2N), and may be referred to as vehicle-to-everything (V2X). The allocation of V2V resources in cellular, i.e., time and frequency resources, can be either controlled by the cellular network structure or performed autonomously by the individual vehicles (e.g. UE devices thereof). Sidelink may use same or different carrier frequencies or frequency bands than cellular communication.

For Rel-18, the NR Sidelink Evolution work item (RP-213678) was approved, where one of the objectives is to enable sidelink operation in FR2, with the following justification:
“ . . . Although NR sidelink was initially developed for V2X applications, there is growing interest in the industry to expand the applicability of NR sidelink to commercial use cases. For commercial sidelink applications, two key requirements have been identified:
   Increased sidelink data rate
   Support of new carrier frequencies for sidelink
Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the FR2 sidelink operation, increased data rate can be more efficiently supported on FR2. While the support of new carrier frequencies and larger bandwidths would also allow to improve its data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications . . . .”

The objective text is as follows:
“ . . . Study and specify enhanced sidelink operation on FR2 licensed spectrum [RAN1, RAN2, RAN4] (This part of the work is put on hold until further checking in RAN #97)
   Update evaluation methodology for commercial deployment scenario
   Work is limited to the support of sidelink beam management (including initial beam-pairing, beam maintenance, and beam failure recovery, etc) by reusing existing sidelink CSI framework and reusing Uu beam management concepts wherever possible.
      Beam management in FR2 licensed spectrum considers sidelink unicast communication only . . . .”

During 3GPP Rel-16, NR sidelink (SL) has been designed to facilitate a user equipment (UE) to communicate with other nearby UE(s) via direct/SL communication. Two resource allocation modes have been specified, and a SL transmitter (TX) UE may be configured with one of them to perform its NR SL transmission(s). These modes are denoted as NR SL mode 1 and NR SL mode 2. In mode 1, a sidelink transmission resource is assigned (scheduled) by the network (NW) to the SL TX UE, while a SL TX UE in mode 2 autonomously selects its SL transmission resources.

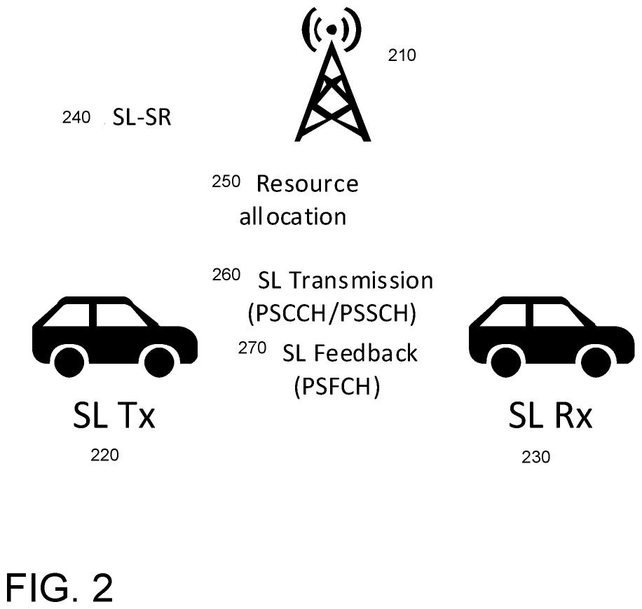

Referring now to FIG. 2, illustrated is a non-limiting example of NR SL resource allocation mode 1. A SL TX UE (220) may transmit a sidelink scheduling request (SL-SR) (240) to the network (210), and may receive a resource allocation (250) in response. The SL UE TX (220) may transmit a SL transmission (PSCCH/PSSCH) (260) to a SL RX UE (230) using the received resource allocation. The SL RX UE (230) may transmit a SL Feedback (PSFCH) to the SL TX UE (220).

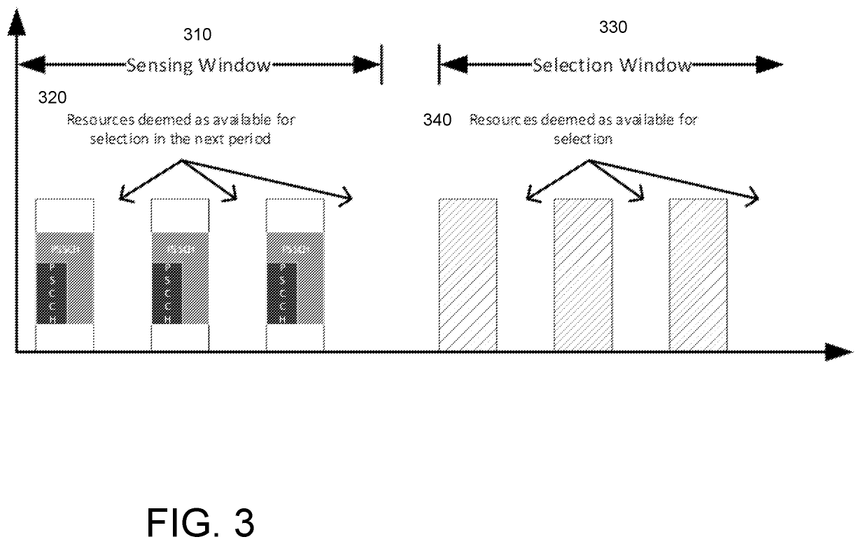

Referring now to FIG. 3, illustrated is a non-limiting example of NR SL resource allocation mode 2. During a sensing window (310), a SL TX UE may make measurements and deem certain resource(s) as available for selection in the next period (320). During a selection window (330), the SL TX UE may select SL transmission resource(s) from the resources that were deemed as available for selection (340).

The configuration of the resources in the sidelink resource pool defines the minimum information required for a RX UE to be able to decode a transmission, which may include the number of sub-channels, the number of physical resource blocks (PRBs) per sub-channel, the number of symbols in the physical sidelink control channel (PSCCH), which slots have a physical sidelink feedback channel (PSFCH), other configuration aspects, etc.

The details of the actual sidelink transmission (i.e., the payload) may be provided in the PSCCH (e.g. 1st-stage SCI) for each individual transmission, which may include: the time and frequency resources, the demodulation reference signal (DMRS) configuration of the physical sidelink shared channel (PSSCH), the modulation and coding scheme (MCS), PSFCH, etc.

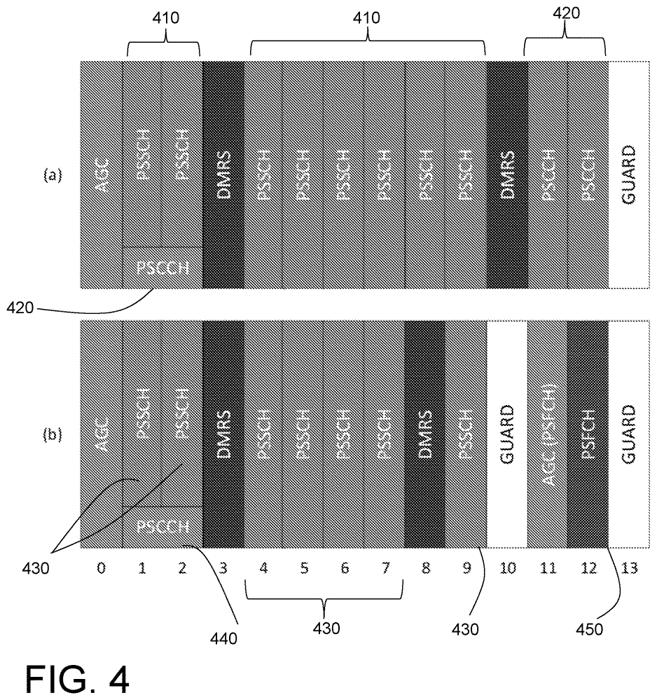

Referring now to FIG. 4, illustrated are examples of SL physical layer slot structure/format. In example (a), illustrated is an example of a slot with PSCCH (420) and PSSCH (410). In example (b), illustrated is an example of a slot with PSCCH (440) and PSSCH (430) where the last symbols are used for PSFCH (450).

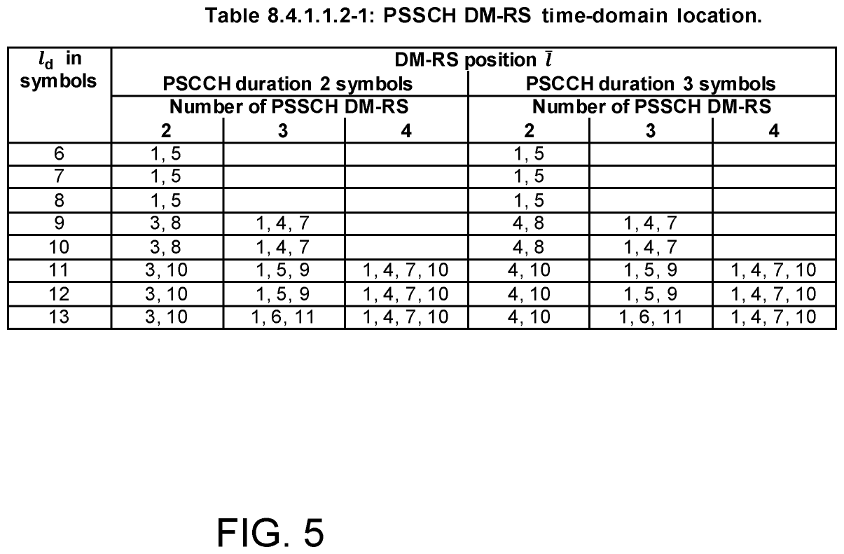

The configuration of the PSCCH (e.g., DMRS, MCS, number of symbols used, etc.) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1st-stage sidelink control information (SCI) which is the payload sent within the PSCCH, and may follow the configuration depicted in FIG. 5. Referring now to FIG. 5, illustrated are examples PSSCH DMRS configurations based on the number of used symbols and duration of the PSCCH [TS 38.211].

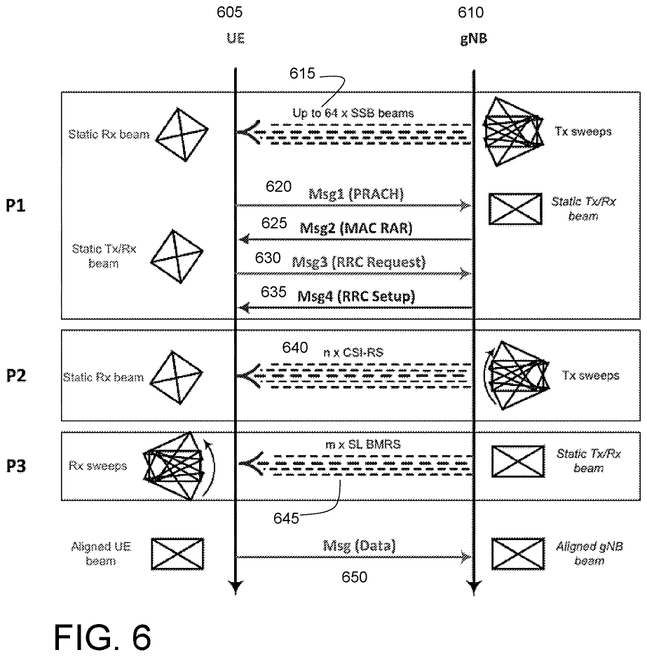

Uu beam management is defined in three phases as described in 3GPP TS 38.214 section 5.1.5 (TCI and QCL framework) and section 5.1.6 (CSI-RS reception procedures), with the signaling diagram found in FIG. 6. Referring now to FIG. 6, illustrated is an example signaling diagram of a Uu beam alignment procedure. In Phase #1, the UE (605) may use a broad Rx beam while the gNB (610) is performing SS burst (615), where up to 64 SSB beams may be swept and transmitted in different angular directions covering the cell. The UE (605) may measure RSRP for all SSB beams on all UE panels, and may send PRACH on the RACH Occasion associated to the best SSB beam (620) to connect to the network (610) with the reciprocal transmit (Tx) beam of the best SSB beam (e.g. SSB beam with the highest received RSRP at the UE receiver and/or the SSB beam with the closest RACH opportunity in time). For example, the gNB (610) may respond with a Msg 2 including MAC random access response (RAR) (625). The UE (605) may transmit, to the gNB (610), a Msg3 including a RRC request (630). The gNB (610) may transmit, to the UE (605), a Msg4 including an RRC setup/configuration (635).

In Phase #2, the UE (605) may use a broad Rx beam to receive gNB refined DL CSI-RS beam g within the connected SSB beam (640). The UE (605) may measure RSRP for all CSI-RS beams and reports the best beam ID(s) back to the gNB (610) still using the reciprocal broad Tx beam.

In Phase #3, the gNB (610) may transmit a repeated CSI-RS with the selected beam (645) based on the UE (605) reporting in Phase #2, and the UE (605) may sweep the refined Rx beam settings to identify its best narrow Rx beam.

At the end of Phase #3, alignment between gNB Tx beam and UE Rx beam may be obtained, which may have the technical effect of maximizing directional gain. The UE (605) may then use the identified narrow Rx beam (i.e. aligned beam) to transmit data (650) to the gNB (610).

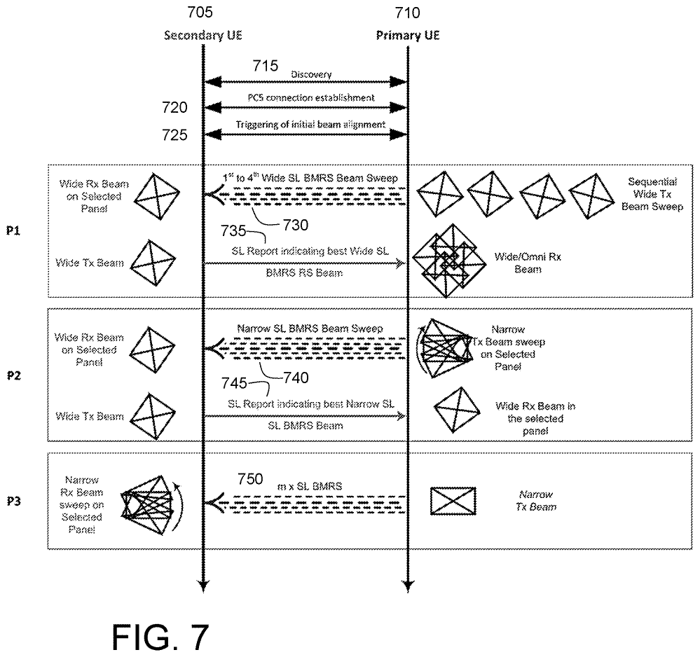

As noted above, sidelink operation in FR2 may be a CSI-RS-based procedure, and may attempt to reuse as much as possible of the Uu beam alignment procedure (e.g. FIG. 6). An example straightforward sidelink beam alignment procedure, inspired by the Uu interface, is illustrated in FIG. 7.

At 715, the secondary UE (S-UE) (705) and the primary UE (P-UE) (710) may perform a discovery procedure, for example following Prose and discovery model A or B. For the case of V2x, the discovery procedure may occur at the V2x layer and may be enabled by the exchange of CAMs in the intelligent transport system (ITS) band at 5.9 GHZ. It may be noted that the discovery procedure may occur in either FR1 or FR2. However, performing the discovery procedure in FR1 may not require performance of beam-based discovery. If the discover procedure is applied at FR2, then it may need to be performed with only wide beams, so discovery may be limited in coverage and may take a long time for devices only capable of transmitting from a single panel at the time (e.g. current smartphone UE implementation).

At 720, the P-UE (710) and the S-UE (705) may establish a unicast link via PC5 connection establishment. This may be performed at either FR1 or FR2.

At 725, the P-UE (710) or the S-UE (705) may trigger the initial beam alignment. This trigger may occur at either FR1 or FR2, and may indicate configuration details on the beam alignment (e.g. SL Beam Management Reference Signals (SL-BMRS) format to be used, number of expected beam sweeps, the time period where the beam sweeps are expected, etc.).

During Phase #1 (P1), at 730, the P-UE (710) may perform a wide SL-BMRS beam sweep. This may be performed in FR2. In an example embodiment, each individual SL-BMRS may be transmitted in a single SL slot. Therefore, if four wide beam sweeps are required, then the P-UE (710) may transmit 4 distinct SL slots, each with a different beam applied. In an example embodiment, the S-UE (705) may perform panel sweeping, in order to determine which panel it should apply to receive the P-UE reference signals.

At 735, the S-UE may report to the P-UE what was the best wide SL-BMRS beam (e.g. the index or slot of the SL-BMRS beam received with the highest power). This report may be transmitted in FR1 or FR2. This may correspond to the completion of P1.

During Phase #2 (P2), at 740, the P-UE (710) may perform the Narrow SL-BMRS beam sweep. This may be performed with FR2. As at 730, it may be assumed that this sweep will utilize a single SL slot per beam sweep.

At 745, the S-UE (705) may report, to the P-UE (710), what was the best narrow SL-BMRS beam. This report may be transmitted in FR1 or FR2. This may correspond to the completion of P2.

During Phase #3 (P3), at 750, the P-UE (710) may perform “m” repetitions of the SL-BMRS while applying the selected narrow Tx beam. The S-UE (705) may perform a narrow Rx beam sweep with the purpose of identifying the best narrow Rx beam.

In the example procedure of FIG. 7, the term SL BMRS is used to refer to the sequences to be used to aid on the beam alignment. However, this is not limiting; these sequences can also take other names, such as Beam Alignment Reference Sequence (BARS), or SL CSI, etc.

The steps in sidelink beam management (and also in the Uu) may be grouped into initial beam-pairing phase (P1), alignment with a narrower Tx beam phase (P2) and finally alignment with a narrower Rx beam phase (P3). As depicted in FIG. 7, each of these steps may be costly in terms of signaling overhead, as reference signals may need to be exchanged between Tx and Rx UEs in order to complete the beam alignment.

To quantify the signaling overhead associated with this procedure, it may be noted that: a Primary UE (P-UE) and Secondary UE (S-UE) may each have 4 panels, where each panel may generate 1 wide beam or one of 5 narrower beams; and a Tx UE may be restricted to apply the same Tx beamformer during a full slot, in order to avoid the occurrence of automatic gain control (AGC) issues at other Rx UEs.

Assuming that each sweep requires a full SL slot, then the number of SL slots required for each of the beam alignment phases may be as illustrated in TABLE 1:

TABLE 1

| | Tx beam/panel | Rx beam/panel | Total slots per phase = |
|---|---|---|---|
| Phase | sweep | sweep | Tx slot × Rx slot |
| P1 | 4 (panel) | 4 (panel) | 16⁽¹⁾ |
| P2 | 5 (narrow beam) | 1 (wide beam) | 5 |
| P3 | 1 (narrow beam) | 5 (narrow beam) | 5 |

| | |
|---|---|
| Total sweeps (P1 + P2 + P3) | 26 |

Note
⁽¹⁾The assumption for this calculation is that there is some form of time alignment to allow the devices to perform panel sweep. In case there is no such alignment and all the 16 combinations need to be established in a random manner, then the total number of panel sweeps could be, on average, 54 (i.e. following the coupon collector problem).

It may be noted that, from a Tx beam sweeping perspective, the assumption of the use of a full slot when applying a specific beam/panel sweep is in place to ensure that there is no AGC Rx disruption at the devices in the proximity of the UE performing the beam sweep.

The number of required slots to achieve beam alignment, as shown in TABLE 1, is quite large. A technical effect of example embodiments of the present disclosure may be to reduce the overhead associated with beam alignment. A technical effect of example embodiments of the present disclosure may be to reduce the number of required beam sweeps.

It may be noted that Rx sweeping of the full slot may not, in principle, be required. It may be noted that any transmission can, in principle, be used to perform an Rx sweep. A technical effect of example embodiments of the present disclosure may be to optimize the Rx beam sweeping based on one or both of these observations. A technical effect of example embodiments of the present disclosure may be to reduce the number of slots required for achieving beam alignment. For example, as depicted in TABLE 2, the number of slots required for achieving beam alignment may be reduced to 9 based on Rx beam sweeping optimization(s) according to example embodiment(s) of the present disclosure, which is substantial when compared to the original 26 slots required (e.g. in TABLE 1):

TABLE 2

| | Tx beam/panel | Rx beam/panel | Total slots per phase = |
|---|---|---|---|
| Phase | sweep | sweep | Tx slot × Rx slot |
| P1 | 4 (panel) | 1 (panel) | 4 |
| P2 | 5 (beam) | 1 (beam) | 5 |

| | |
|---|---|
| Total sweeps (P1 + P2 + P3) | 9 |

In an example embodiment, optimizations from a Rx beam sweeping perspective may be enabled.

In an example embodiment, a procedure may be implemented to enable a UE to perform Rx beam alignment in an opportunistic way. A technical effect of example embodiments of the present disclosure may be to minimize the amount of overhead required for Rx beam alignment (e.g. minimize Rx beam/panel sweeps in P1 and P3).

In the present disclosure, “opportunistic” may mean that the Rx UE may use transmissions from the Tx UE, which are not necessarily intended for the Rx UE, to identify which Rx beam to apply when receiving a transmission from that Tx UE in the future. For example, the used transmissions from the Tx UE may not be intended for the Rx UE at all, may be intended for the Rx UE as well as another UE, may be groupcast transmissions, may be broadcast transmissions, etc.

In the present disclosure, the terms “UE-Rx” and “UE-RX,” with and without the hyphen, may be used interchangeably to refer to the UE performing opportunistic Rx beam alignment. In the present disclosure, the terms “UE-Tx” and “UE-TX,” with and without the hyphen, may be used interchangeably to refer to the UE(s) of which transmission(s) may be used to accomplish the UE-Rx's opportunistic Rx beam alignment.

In an example embodiment, a UE-Rx or a UE-Tx may request use of an opportunistic Rx beam alignment procedure. In an example embodiment, the UE-Rx, prior to acquiring a valid Rx beam towards a UE-Tx (e.g. an Rx beam that may allow the Rx-UE to receive a transmission from the Tx-UE), may, upon the start of the beam alignment procedure, indicate to the UE-Tx that it will attempt to acquire in an opportunistic manner the Rx beam alignment based on the UE-Tx's transmissions towards other UEs. In an example embodiment, if the UE-Rx is aware of multiple UE-Txs, the UE-Rx may indicate that intends to perform an opportunistic Rx beam alignment procedure to all, or a subset of, these UE-Txs. In another example embodiment, the UE-RX may be requested by the UE-Tx to attempt to acquire in an opportunistic manner the Rx beam alignment based on the UE-Tx's transmission(s) towards other UEs. In an example embodiment, the opportunistic Rx beam alignment may occur/continue until successful (i.e. no time limit associated with this procedure), or it may be (pre-) configured to occur/continue over a time period, after which if the UE-Rx has not been able to acquire a suitable Rx beam alignment, it may request the start of normal (i.e. non-opportunistic) beam alignment procedure(s).

In an example embodiment, a UE may request use of an opportunistic Rx beam alignment procedure. For example, the UE may explicitly indicate that it wants to perform opportunistic beam alignment. Alternatively, the UE may explicitly indicate that it does not want to perform opportunistic beam alignment, or may explicitly indicate that an opportunistic beam alignment procedure is inappropriate. Additionally or alternatively, the UE may request to use a non-opportunistic beam alignment procedure.

In an example embodiment, a UE may receive a request to use an opportunistic Rx beam alignment procedure. The UE may accept the request to use the opportunistic beam alignment procedure. Alternatively, the UE may decline the request to use the opportunistic beam alignment procedure. The UE may indicate that, instead, non-opportunistic beam alignment may be performed. For example, the UE may indicate that non-opportunistic beam alignment may be performed even though opportunistic beam alignment was requested because the UE may know (e.g. when the UE is the first UE/Tx UE) that it may not have sufficient traffic to enable opportunistic beam alignment.

In an example embodiment, the UE may receive a request to use a non-opportunistic beam alignment procedure. The UE may accept the request to use the non-opportunistic beam alignment procedure. Alternatively, the UE may decline the request to use the non-opportunistic beam alignment procedure. The UE may indicate that, instead, opportunistic beam alignment may be performed. For example, the UE (e.g. when the UE is the first UE/Tx UE) may decline the non-opportunistic beam alignment request because it may know that it will have sufficient traffic (i.e. transmissions) in the near future that can be used to support the opportunistic beam alignment.

In an example embodiment, the UE-Rx, after acquiring a valid Rx beam towards a UE-Tx, may, upon the start of the beam alignment procedure, indicate that it has already acquired a valid Tx/Rx beam.

In an example embodiment, requesting for opportunistic Rx beam alignment procedure may include the exchange of additional information, as such positioning assistance data/QCL information. This additional information may define panel ID, orientations, spatial relationships, etc. Additional information may be requested, or provided in a request, by either of the UE-RX or the UE-TX(s).

In an example embodiment, the UE-Tx may transmit an indication of the type of beamforming being applied to the UE-Tx's current transmission in either the 1st or 2nd stage SCI. In an example embodiment, the type of beamforming may be indicated in a sidelink transmission configuration indicator (SL-TCI). This SL-TCI may provide the QCL-relationship between the SL CSI-RS and the rest of the transmission in a SL slot (e.g. PSCCH and PSSCH DMRS). Alternatively, this SL-TCI may provide the same information as beam ID. For example, a SL Tx indicating that it is using SL-TCI n in its transmission may mean that it is applying beamformer n to its transmission. In an example, the UE-Rx may receive such an indication from one or more UE-Txs. In an example embodiment, this indication may allow the UE-Rx to determine if the UE-Tx's current transmission is suitable for opportunistic Rx beam alignment. For example, a wider beam might be more suitable for an Rx panel sweep, while a narrower beam might be more suitable for an Rx beam sweep after a Rx panel has been identified. For example, Tx beams associated with UE-Tx with high mobility may not be suitable for opportunistic Rx beam alignment, since any determined Rx beam may stop being valid after a short time. In an example embodiment, this indication may be a single bit indicating if the beamformer applied to the UE-Tx transmission corresponds to a wide beam or a narrow beam. In an example embodiment, this indication may be multiple bits indicating what is the associated Tx beam ID and/or Tx panel ID being used for the UE-Tx's current transmission. In an example embodiment, this indication may also include the information of whether symbols with CSI-RS are present in the current slot or not.

In an example embodiment, the UE-Rx may determine which UE-Tx(s) for which it should attempt to perform opportunistic Rx beam alignment. For example, if the UE-Rx is aware of multiple candidate UE-Txs, for example UE-Txs from which an indication/SCI has been received, the UE-Rx may determine to perform opportunistic Rx beam alignment with one, some, or all of the multiple UE-Txs. In an example embodiment, the determination may be made prior to the start of the beam alignment procedure between the UE-Rx and UE-Tx. The determination may be to include any UE-Tx for which the activity (i.e. transmissions) is detected within the resource pool. Additionally or alternatively, the determination may include any UE-Tx for which a unicast link has been established or is expected to be established (i.e. a UE for which a PC5-RRC connection establishment has taken or will take place). Additionally or alternatively, this determination may include any UE-Tx for which the activity (i.e. transmissions) is detected within the resource pool and if a specific condition (or set of conditions) is met. For example, the condition(s) may include that the RSRP associated with the UE-Tx's SCI is above a RSRP threshold (e.g. RSRP associated with PSCCH (conveying SCI-1); RSRP associated with SCI-2; etc.). For example, the condition(s) may include that the UE-Tx was, in the past, a destination of at least one of the UE-Rx's transmissions. For example, the condition(s) may include that the UE-Rx was, in the past, a destination of at least one of the UE-Tx's transmissions. For example, the condition(s) may include that, in the case of V2x, the UE-Tx transmitted a co-operative awareness message/basic safety message (CAM/BSM) in the past “X” seconds (e.g. a predetermined time period). For example, the condition(s) may include that the UE-Tx has indicated transmission of high priority/high throughput traffic (e.g. based on the indicated L1 priority of the previous UE-Tx transmissions). The intention may be that the Rx-UE should be ready (e.g. proactively beam aligned) towards Tx-UE transmitting high priority data. Otherwise, it may be too late if it finds out later that it needs to do a reactive beam alignment for receiving the data. On the other hand, the Rx-UE may not make the effort to perform opportunistic beam alignment towards a Tx-UE that transmits low priority data, as for such data it may have time to react if beam alignment is needed. In an example embodiment, when the beam alignment procedure has been initiated between the UE-Rx and UE-Tx, then the determination may be based on the start of this procedure.

In an example embodiment, if the UE-Rx determines to perform the opportunistic Rx beam alignment with multiple UE-Txs, the UE-Rx may prioritize the UE-Tx(s) with which it determines to perform the opportunistic Rx beam alignment towards. This prioritization may be based, for example, on whether a UE-Tx is part of a list of UEs that the UE-Rx would like to acquire the Rx beam alignment for. In case there are multiple of these UEs, then the UE-Rx may decide to select the UE-Tx having the highest associated priority (e.g. service or use case priority, which the UE-Rx may receive from its upper layers, such as the V2x or Prose layer). In the case that there are multiple UE-Txs with the same service priority, then the UE-Rx may select one of these randomly (e.g. based on the outcome of a random number generator). In an example embodiment, prioritization of multiple UE-Txs with which the UE-Rx may perform the opportunistic Rx beam alignment may be relevant only if the UE-Txs are performing a transmission in the same time slot. If the multiple UE-Txs perform transmissions in different time slots, prioritization may not be required.

In an example embodiment, the UE-Rx may perform opportunistic Rx beam alignment behavior towards a UE-Tx of interest. In the case of analog beamforming frontend at the UE-Rx, if the UE-Rx is able to decode the UE-Tx's 2^{nd} stage SCI within the same slot and determine the ID of the UE-Tx, it may decide to use the remaining symbols in the slot to perform Rx beam refinement (i.e. fine tuning of the beam alignment). In this setting, the UE-Rx, whenever it has detected the transmission of a UE-Tx of interest (i.e. a UE-Tx for which the transmitter ID in the 2nd stage SCI matches the ID of a UE-Tx of interest and the destination ID in the 2nd stage SCI does not match the UE-Rx), may use the remaining symbols of the slot after decoding the 2nd stage SCI for Rx beam alignment. Additionally or alternatively, the UE-Rx may perform Rx beam sweeping based on DMRS sequence correlation in the remaining DMRS symbols of the slot. Additionally or alternatively, the UE-Rx may perform Rx beam sweeping based on energy detection in the remaining non-DMRS or/and DMRS symbols of the slot.

In the case of analog beamforming frontend at the UE-Rx, the UE-Rx may determine that additional resources are indicated in the 1st stage SCI for retransmission (e.g. within the next 32 slots) or for reserving SPS transmissions towards another UE other than the UE-Rx and then may use these also for Rx beam alignment. In this case, the UE my determine to prioritize to perform Rx beam alignment instead of applying a wide Rx beam that would allow it to receive transmissions from any other devices in the reserved slots. This determination may be based on a condition such as the observed level of activity in the resource pool (e.g. based on the CBR). This determination may be based on a condition such as the lack of transmission(s) of interest in those slots (e.g. the UE-Rx may not be aware of any resource reservation from any other UE-Tx of interest for that specific slot). This determination may be based on a condition such as those slots being outside the common DRX ON periods for broadcast, groupcast (of the groups for which the UE belongs), and/or other unicast links. This determination may be based on a condition such as the expected priority of the communications between UE-Rx and UE-Tx being above a set threshold.

In the case of digital beamforming frontend at the UE-Rx, the UE-Rx may have more relaxed processing time, allowing it to decode the 2nd stage SCI to determine if the UE-Tx transmission is suitable and then may be able to use all the symbols of the UE-Tx transmission to perform the opportunistic Rx beam alignment. For example, the UE-Rx may be able to identify the optimal Rx beam alignment for each UE-Tx transmitted beam/panel IDs with a single UE-Tx transmission using a specific beam/panel ID.

In example an embodiment, the UE-Rx may indicate/report that at least one valid Rx beam is available for the UE-Tx of interest. For example, a valid Rx beam(s) may be an Rx beam(s) that, when applied to receive a Tx transmission, may result in the associated received power (e.g. RSRP) being above a predefined power. The UE-RX, when having identified all the Rx beams that meet that criteria, may then perform ordering/prioritization of these, for example from highest received power to lowest received power. The UE-Rx, upon acquiring a valid Rx beam towards a UE-Tx of interest, may indicate to the UE-Tx of interest that a valid Rx beam(s) is available. Alternatively, upon being requested to start beam alignment procedures by the UE-Tx of interest, the UE-Rx may indicate that a valid Rx beam(s) has already been acquired. In either case, this indication may include if the best Rx beam(s) is towards a wide and/or a narrower beam of the UE-Tx. Additionally or alternatively, this indication may include an indication of to which beam/panel ID(s) of the UE-Tx the N best Rx beams are each relevant. Additionally or alternatively, this indication may include a time stamp to indicate how fresh/recent the acquired Rx beam(s) is. Additionally or alternatively, this indication may include a list of all UE-Tx beam/panel ID that were used to perform the opportunistic Rx beam alignment. Additionally or alternatively, this indication may include a tuple with, for example, Rx beam ID, UE-Tx beam/panel ID, measured RSRP towards UE-Tx reference signals (e.g. CSI-RS or DMRS) and/or measured RSSI (to account with interference associated with the Rx beam) for each valid Rx beam.

In an example embodiment, the UE-Tx, upon receiving the report from the UE-Rx on the outcome of the opportunistic Rx beam alignment, may determine if additional dedicated Tx beam sweeps are required. The report from the UE-Rx, for example when it includes the beam/panel ID of the UE-Tx used to establish a given Rx beam, may be used for this determination. For example, the UE-Tx may determine that the UE-Tx beam/panel IDS provide do not a sufficient representation of all possible beamforming directions (e.g. the Rx beam alignment was mostly performed against a panel or set of beams pointing in the same general direction from the perspective of the UE-Tx). Additionally or alternatively, the time-stamp when the Rx beam alignment was acquired may be deemed to be too old when compared with the mobility profile of the UE-Tx (i.e. when the UE-Tx has high mobility, then any acquired Rx beam alignment may need to be very recent). Additionally or alternatively, the UE-Tx may determine that it has been too long time since it had used the indicated Tx beams that was indicated by the UE-Rx.

The following description considers the cases where the opportunistic Rx beam alignment procedure occurs before and after unicast link establishment, but always assuming that it occurs before beam alignment has been established between the UE-Rx and UE-Tx. However, the same procedure may also be applied to aid on beam alignment maintenance. More specifically, even though the UE-Rx may have already established a valid Rx beam towards the UE-Tx, it may still try to exploit the transmissions of the UE-Tx towards other UEs to identify other valid candidates that it could use to establish a Rx beam towards the UE-Tx.

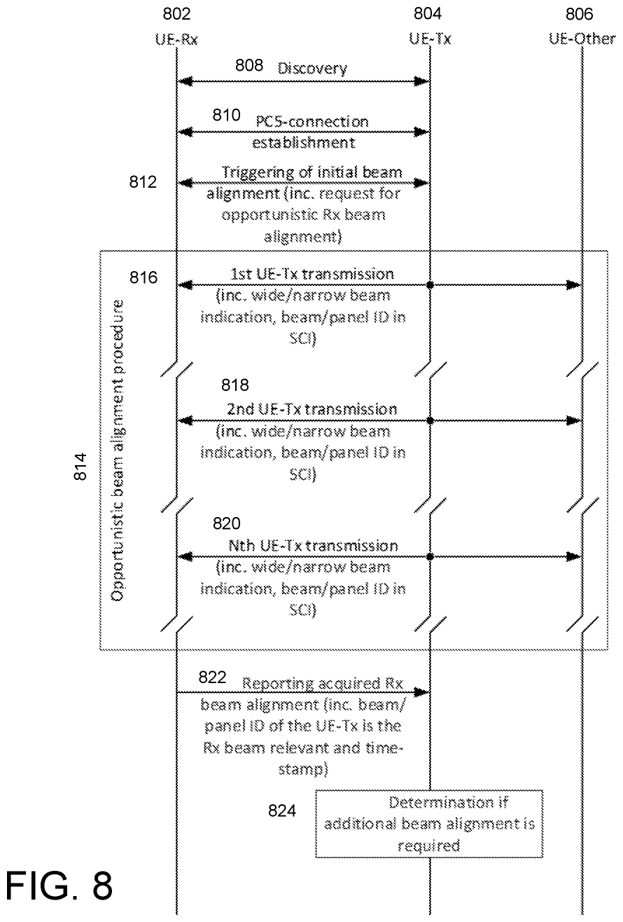

Referring now to FIG. 8, illustrated is an example of signaling for supporting/enabling an opportunistic Rx beam alignment procedure after unicast link establishment.

At 808, a UE-RX (802) and a UE-TX (804) may perform a discovery procedure. For example, the discovery procedure may follow ProSe and discovery model A or B. For the case of V2x, the discovery may occur at the V2x layer and may be enabled by the exchange of CAMs in the ITS band at 5.9 GHZ. In an example embodiment, the discovery procedure may occur in either FR1 or FR2. However, the benefit of doing discovery in FR1 is the absence of the need to perform beam-based discovery. If applied at FR2, then it may need to be performed with only wide beams, so discovery may be limited in coverage and take a long time for devices only capable of transmitting from a single panel at the time (e.g. current smartphone UE implementation).

At 810, the UE-Rx (802) and the UE-Tx (804) may establish a unicast link via PC5 connection establishment. This may either be performed at FR1 or FR2.

At 812, the UE-Rx (802) or the UE-Tx (804) may trigger the initial beam alignment. This trigger may occur at either FR1 or FR2, and may indicate configuration details on the beam alignment (e.g. SL Beam Management Reference Signals (SL-BMRS) format to be used, number of expected beam sweeps, the time period where the beam sweeps are expected, etc.). In an example embodiment, in the case of triggering of initial beam alignment by the UE-Tx (804), the UE-Tx (804) may request the UE-Rx (802) to perform opportunistic Rx beam alignment based on the UE-Tx upcoming transmissions to UE-Other (806). The UE-Rx (802), upon receiving the UE-Tx's request to initiate beam alignment, instead of confirming it may instead reply with an indication that it will attempt Rx beam alignment based on the UE-Tx upcoming transmission to UE-Other (806). In an example embodiment, in the case of triggering of initial beam alignment by the UE-Rx (802), the UE-Rx (802) may indicate to the UE-Tx (804) that it will perform opportunistic Rx beam alignment based on the UE-Tx upcoming transmissions to UE-Other (806). The UE-Tx (804), upon receiving the UE-Rx's request to initiate beam alignment, instead of confirming it may instead reply with a request for the UE-Rx (802) to attempt RX beam alignment based on the UE-Tx upcoming transmission to UE-Other (806). The step(s) at 812 may be considered to correspond to the description above of the UE-Rx or the UE-Tx requesting for opportunistic Rx beam alignment procedure (e.g. at paragraph [0077]).

The UE-RX (802) may then initiate an opportunistic beam alignment procedure (814). At 816, the UE-Tx (804) may perform transmission to the UE-Other (806) and may include in SCI (e.g. 1st or 2nd stage SCI) information elements that may enable the UE-Rx (802) to perform opportunistic Rx beam alignment. For example, this information may include the type of beam (e.g. wide or narrow), the panel and/or beam ID, an indication of whether the UE-Tx (804) is experiencing high mobility or not, an indication of whether CSI-RS symbols are present or not in the current slot, etc. The step(s) at 816 may be considered to correspond to the description above of the UE-Tx indicating the type of beamforming being applied to the UE-Tx's current transmission in either the 1st or 2nd stage SCI (e.g. at paragraph).

The UE-TX (804) may perform transmission multiple times similar to that at 816. In the example of FIG. 8, during the opportunistic beam alignment procedure (814) the UE-TX (804) may perform transmission at 816, 818, and 820. However, this is not limiting; during an opportunistic beam alignment procedure the UE-TX may perform transmission similar to that at 816 “N” times, N≥1. In other words, UE-RX (802) may monitor UE-TX (804) transmission(s) until beam alignment has been acquired.

At 822, the UE-RX (802) may report that opportunistic Rx beam alignment has been acquired. In an example embodiment, the report may include, at least, information about the UE-Tx (804) beam/panel used to establish the Rx beam alignment. The step(s) at 822 may be considered to correspond to the description above of UE-Rx indicating/reporting that a valid Rx beamformer is available for the UE-Tx of interest (e.g. at paragraph).

At 824, the UE-Tx (804) may determine if additional beam alignment is required. The step(s) at 824 may be considered to correspond to the description above of the UE-Tx, upon receiving a report from the UE-Rx on the outcome of the opportunistic Rx beam alignment, determining if additional dedicated Tx beam sweeps are required (e.g. at paragraph [0090]).

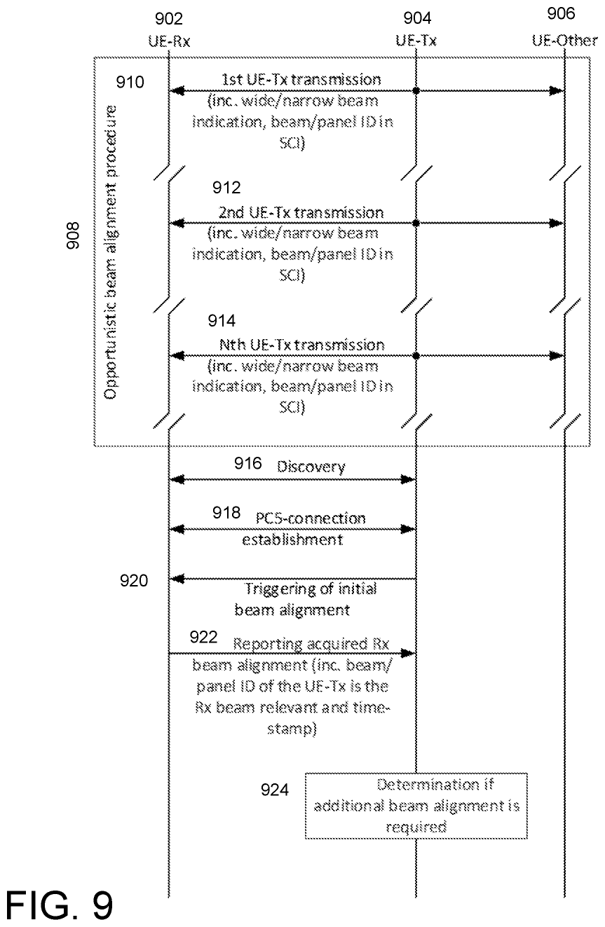

Referring now to FIG. 9, illustrated is an example of signaling for supporting/enabling opportunistic Rx beam alignment procedure prior to unicast link establishment.

At 908, the UE-RX (902) may perform opportunistic beam alignment procedure.

At 910, the UE-Tx (904) may perform transmission to the UE-Other (906). The UE-Tx (904) may include in SCI (e.g. 1st or 2nd stage SCI) information element(s) that may enable the UE-Rx to perform opportunistic Rx beam alignment. For example, the information may include the type of beam (e.g. wide or narrow), the panel and/or beam ID, indication if the UE-Tx is experiencing high mobility or not, indication if CSI-RS symbols are present or not in the current slot, etc. The step(s) at 910 may be considered to correspond to the description above of UE-Rx indicating/reporting that a valid Rx beamformer is available for the UE-Tx of interest (e.g. at paragraph [0083]).

The UE-TX (904) may perform transmission multiple times similar to that at 910. In the example of FIG. 9, during the opportunistic beam alignment procedure (908) the UE-TX (904) may perform transmission at 910, 912, and 914. However, this is not limiting; during an opportunistic beam alignment procedure the UE-TX may perform transmission similar to that at 910 “N” times, N≥1. In other words, UE-RX (902) may monitor UE-TX (904) transmission(s) until beam alignment has been acquired.

At 916, UE-RX (902) and UE-TX (904) may perform a discovery procedure, for example following ProSe and discovery model A or B. For the case of V2x, the discovery procedure may occur at the V2x layer and may be enabled by the exchange of CAMs in the ITS band at 5.9 GHZ. The discovery procedure may occur in either FR1 or FR2. However, the benefit of doing this in FR1 may be the absence of the need to perform beam-based discovery. If applied at FR2, then it may need to be performed with only wide beams, so discovery may be limited in coverage and may take a long time for devices only capable of transmitting from a single panel at the time (e.g. current smartphone UE implementation).

At 918, the UE-Rx (902) and the UE-Tx (904) may establish a unicast link via PC5 connection establishment. This may be performed at either FR1 or FR2.

At 920, the UE-Rx (902) or the UE-Tx (904) may trigger the initial beam alignment. This trigger may occur at either FR1 or FR2, and may indicate configuration details on the beam alignment (e.g. SL Beam Management Reference Signals (SL-BMRS) format to be used, number of expected beam sweeps, the time period where the beam sweeps are expected, etc.). In the case of triggering of initial beam alignment by the UE-Tx (904), the UE-Tx (904) may request the UE-Rx (902) to perform opportunistic Rx beam alignment based on the UE-Tx (904) upcoming transmissions to UE-Other (906). The UE-Rx (902), upon receiving the UE-Tx's request to initiate beam alignment, instead of confirming it may reply with an indication that it will attempt Rx beam alignment based on the UE-Tx (904) upcoming transmission to UE-Other (906). In the case of triggering of initial beam alignment by the UE-Rx (902), the UE-Rx (902) may indicate to the UE-Tx (904) that it will perform opportunistic Rx beam alignment based on the UE-Tx upcoming transmissions to UE-Other (906). The UE-Tx (904), upon receiving the UE-Rx's request to initiate beam alignment, may, instead of confirming it, reply with a request for the UE-Rx (902) to attempt Rx beam alignment based on the UE-Tx upcoming transmission to UE-Other (906). The step(s) at 920 may be considered to correspond to the description above of the UE-Rx or the UE-Tx requesting for opportunistic Rx beam alignment procedure (e.g. at paragraph).

At 922, The UE-RX (902) may perform reporting that opportunistic Rx beam alignment has been acquired. This may include, at least, information about the UE-Tx beam/panel used to establish the Rx beam alignment. The step(s) at 922 may be considered to correspond to the description above of UE-Rx indicating/reporting that a valid Rx beamformer is available for the UE-Tx of interest (e.g. at paragraph).

At 924, the UE-Tx (904) may determine if additional beam alignment is required. The step(s) at 922 may be considered to correspond to the description above of the UE-Tx, upon receiving a report from the UE-Rx on the outcome of the opportunistic Rx beam alignment, determining if additional dedicated Tx beam sweeps are required (e.g. at paragraph [0090]).

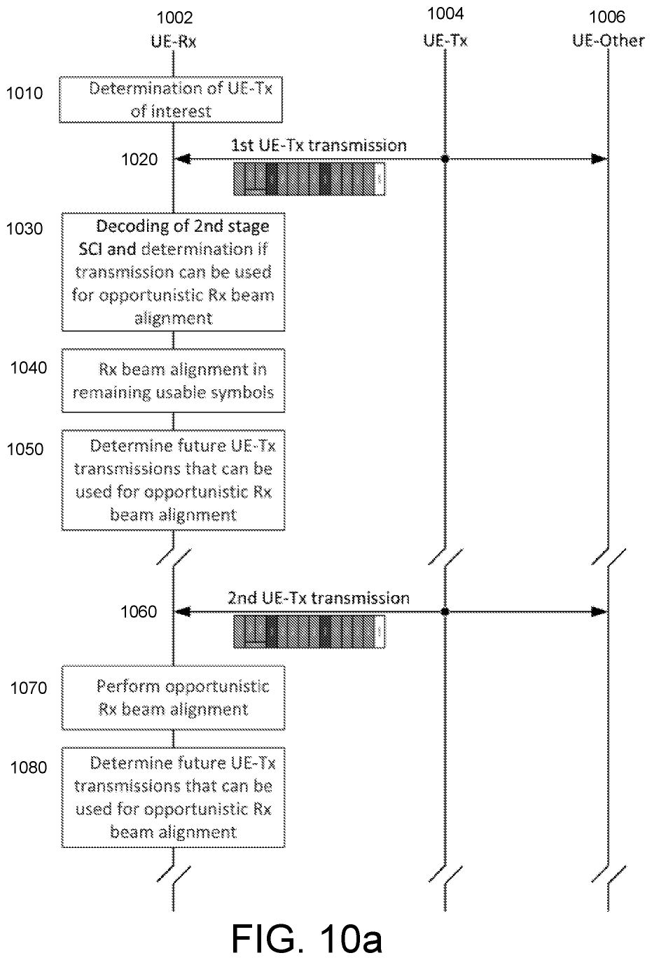

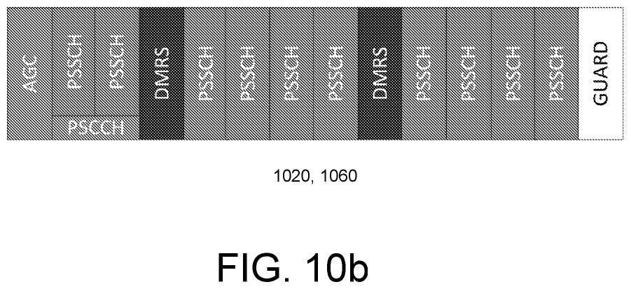

Referring now to FIG. 10a, illustrated is an example of an opportunistic Rx beam alignment procedure according to an example embodiment of the present disclosure.

At 1010, there may be a determination at UE-Rx (1002) or the UE-Tx (1004) to monitor for opportunistic Rx beam alignment. The step(s) at 1010 may be considered to correspond to the description above of the UE-RX determining with which UE-Tx(s) it should attempt to perform opportunistic Rx beam alignment (e.g. at paragraph [0084]).

At 1020, the UE-Rx (1002) may receive the UE-Tx (1004) transmission. An example of the transmission, with greater detail, is illustrated at FIG. 10b. This transmission may include additional information that may facilitate the Rx beam alignment. The step(s) at 1020 may be considered to correspond to the description above of an indication by the UE-Tx of the type of beamforming being applied to the UE-Tx's current transmission in either the 1st or 2nd stage SCI (e.g. at paragraph [0083]).

At 1030, the UE-Rx (1002) may decode the 2nd stage SCI and may determine if the current transmission can be used for opportunistic Rx beam alignment. This determination may be based on whether the current UE-Tx transmission is taking place while the UE-Tx is experiencing high mobility conditions. Additionally or alternatively, this determination may be based on whether the beamformer applied to the UE-Tx transmission is suitable or not (e.g. a wider beam might be more suitable for Rx panel sweep, while a narrower beam might be more suitable for Rx beam sweep after a Rx panel has been identified). The step(s) at 1030 may be considered to correspond to the description above of an indication by the UE-Tx of the type of beamforming being applied to the UE-Tx's current transmission in either the 1st or 2nd stage SCI (e.g. at paragraph [0083]).

At 1040, if the 2nd stage SCI was decoded before the UE-Rx has finished receiving the UE-Tx transmission, then the remaining symbols of the current transmission may still be used for RX beamforming. The step(s) at 1040 may be considered to correspond to the description above of UE-Rx opportunistic Rx beam alignment behavior towards a UE-Tx of interest, in the case of analog beamforming frontend at the UE-Rx, where if the UE-Rx is able to decode the UE-Tx's 2nd stage SCI within the same slot and determine the ID of the UE-Tx, it may decide to use the remaining symbols in the slot to perform Rx beam refinement (e.g. at paragraph [0086]).

At 1050, the UE-RX (1002) may determine based on the 1st stage SCI if the UE-Tx has future transmissions (either for blind repetitions or SPS) that may be used by the UE-Rx (1002) to perform opportunistic Rx beam alignment. The step(s) at 1050 may be considered to correspond to the description above of UE-Rx opportunistic Rx beam alignment behavior towards a UE-Tx of interest, in the case of analog beamforming frontend at the UE-Rx, the UE-Rx may determine that additional resources are indicated in the 1st stage SCI for retransmission (e.g. within the next 32 slots) or for reserving SPS transmissions towards another UE other than the UE-Rx, and then may use these also for Rx beam alignment (e.g. at paragraph [0087]).

At 1060, the UE-Rx (1002) may receive the UE-Tx transmission. An example of the transmission, with greater detail, is illustrated at FIG. 10b. This transmission may include additional information that may facilitate the Rx beam alignment. The step(s) at 1060 may be considered to correspond to the description above of indication by the UE-Tx of the type of beamforming being applied to the UE-Tx's current transmission in either the 1st or 2nd stage SCI (e.g. at paragraph [0083]).

At 1070, the UE-Rx (1002) may perform opportunistic Rx beam alignment using either all the symbols of the UE-Tx's transmission or only the symbols occurring after the symbols mapped for the 2nd stage SCI. The step(s) at 1070 may be considered to correspond to the description above of UE-Rx opportunistic Rx beam alignment behavior towards a UE-Tx of interest, in the case of analog beamforming frontend at the UE-Rx, the UE-Rx may determine that additional resources are indicated in the 1st stage SCI for retransmission (e.g. within the next 32 slots) or for reserving SPS transmissions towards another UE other than the UE-Rx, and then may use these also for Rx beam alignment (e.g. at paragraph [0087]).

At 1080, the UE-RX (1002) may perform a step(s) as at 1050.

In an example embodiment, the opportunistic Rx beam alignment may be applied to UE-Tx transmissions that contain only data as well as transmissions that include CSI-RS (e.g. which may be used with the goal to facilitate beam alignment).

A technical effect of example embodiments of the present disclosure may be to enable utilizing of the UE-Tx transmissions to other UEs other than the UE-Rx, which may have the technical effect of reducing the amount of resources dedicated to beam alignment.

A technical effect of example embodiments of the present disclosure may be, in the extreme case (e.g. in the case the UE-Rx is able to observe/measure all the Tx beams from the UE-Tx), to enable a complete beam alignment to be established between the UE-Tx and UE-Rx without the need of dedicated resources for the beam alignment.

A technical effect of example embodiments of the present disclosure may be to enable usage with traditional beam alignment.

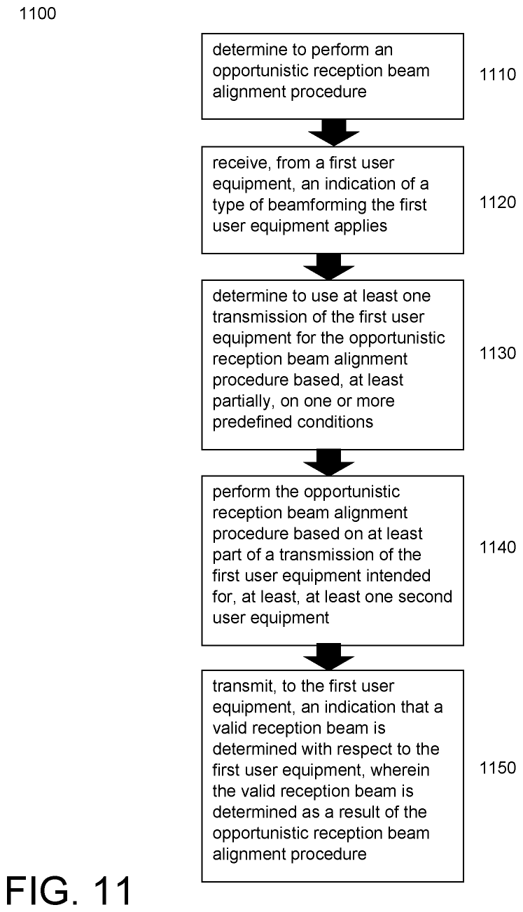

FIG. 11 illustrates the potential steps of an example method 1100. The example method 1100 may include: determining to perform an opportunistic reception beam alignment procedure, 1110; receiving, from a first user equipment, an indication of a type of beamforming the first user equipment applies, 1120; determining to use at least one transmission of the first user equipment for the opportunistic reception beam alignment procedure based, at least partially, on one or more predefined conditions, 1130; performing the opportunistic reception beam alignment procedure based on at least part of a transmission of the first user equipment intended for, at least, at least one second user equipment, 1140; and transmitting, to the first user equipment, an indication that a valid reception beam is determined with respect to the first user equipment, wherein the valid reception beam is determined as a result of the opportunistic reception beam alignment procedure, 1150.

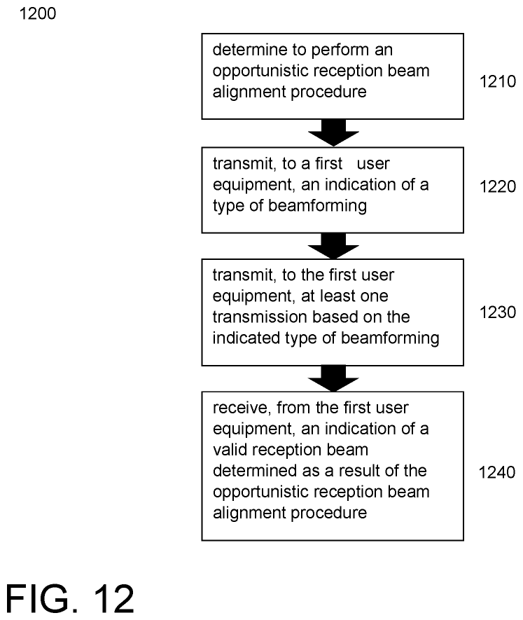

FIG. 12 illustrates the potential steps of an example method 1200. The example method 1200 may include: determining to perform an opportunistic reception beam alignment procedure, 1210; transmitting, to a first user equipment, an indication of a type of beamforming, 1220; transmitting, to the first user equipment, at least one transmission based on the indicated type of beamforming, 1230; and receiving, from the first user equipment, an indication of a valid reception beam determined as a result of the opportunistic reception beam alignment procedure, 1240.

In accordance with one example embodiment, an apparatus may comprise: at least one processor; and at least one memory storing instructions that, when executed by the at least one processor, cause the apparatus at least to: determine to perform an opportunistic reception beam alignment procedure; receive, from a first user equipment, an indication of a type of beamforming the first user equipment applies; determine to use at least one transmission of the first user equipment for the opportunistic reception beam alignment procedure based, at least partially, on one or more predefined conditions; perform the opportunistic reception beam alignment procedure based on at least part of a transmission of the first user equipment intended for, at least, at least one second user equipment; and transmit, to the first user equipment, an indication that a valid reception beam is determined with respect to the first user equipment, wherein the valid reception beam may be determined as a result of the opportunistic reception beam alignment procedure.

Determining to perform the opportunistic reception beam alignment procedure may comprise the example apparatus being configured to: receive a request to perform the opportunistic reception beam alignment procedure based on the transmission of the first user equipment intended for, at least, the at least one second user equipment.

The example apparatus may be further configured to: transmit, in response to the received request, an indication of a determination to perform the opportunistic reception beam alignment procedure based on the transmission of the first user equipment intended for, at least, the at least one second user equipment.

Determining to perform the opportunistic reception beam alignment procedure may comprise the example apparatus being configured to: transmit a request to perform the opportunistic reception beam alignment procedure.

The example apparatus may be further configured to: transmit, to the first user equipment, at least one of: positioning assistance data, or quasi co-location information with the request to perform the opportunistic reception beam alignment procedure.

The example apparatus may be further configured to: receive, in response to the transmitted request, a request to perform the opportunistic reception beam alignment procedure based on the transmission of the first user equipment intended for, at least, the at least one second user equipment.

The indication of the type of beamforming the first user equipment applies may be received as at least part of sidelink control information.

The indication of the type of beamforming the first user equipment applies may be received with at least one of: an indication of wide beam use, an indication of narrow beam use, an indication of at least one panel the first user equipment uses for transmission, an indication of at least one beam the first user equipment uses for transmission, an indication of beam identification the first user equipment uses for transmission, an indication of a sidelink transmission configuration indicator associated with the beam the first user equipment uses for transmission, an indication of a mobility the first user equipment is experiencing, or an indication of whether channel state information reference signal symbols are present in a current slot.

The one or more predefined conditions may comprise at least one of: presence of the at least one transmission of the first user equipment in a sidelink resource pool, presence of a unicast link with the first user equipment, a reference signal received power associated with the at least one transmission of the first user equipment is above a threshold value, which panel of the first user equipment uses for transmission, which beam the first user equipment uses for transmission, which beam identification the first user equipment uses for transmission, which sidelink transmission configuration indicator is associated with the beam the first user equipment uses for transmission, current mobility of the first user equipment, a width of a beam of the at least one transmission of the first user equipment, a beam transmission identifier or sidelink transmission configuration indicator the first user equipment uses for transmission that has not yet been used by the apparatus in the opportunistic reception beam alignment procedure, presence, in a current slot, of channel state information reference signal symbols, previous communication of the apparatus with the first user equipment, the first user equipment transmitted a basic safety message or co-operative awareness message within a predetermined time period, or an indicated L1 priority of previous transmissions of the first user equipment is configured to indicate high priority traffic or high throughput traffic.

Performing the opportunistic beam alignment procedure may comprise the example apparatus being configured to: wherein the transmission of the first user equipment may comprise a second stage sidelink control information, wherein a slot may comprise the second stage sidelink control information and may further comprise at least one symbol, use the at least one symbol in the slot for the opportunistic beam alignment procedure.

The at least one symbol may comprise at least one demodulation reference signal, wherein the example apparatus may be further configured to: perform receiver beam sweeping based on demodulation reference signal or channel state information reference signal sequence correlation.

The example apparatus may be further configured to: perform receiver beam sweeping based on energy detection.

Performing the opportunistic beam alignment procedure may comprise the example apparatus being configured to: wherein the transmission of the first user equipment may comprise a first stage sidelink control information, wherein the first stage sidelink control information may be configured to indicate further transmissions of the first user equipment, use at least one of the further transmissions of the first user equipment for the opportunistic beam alignment procedure.

The example apparatus may be further configured to: receive an indication, from the first user equipment, to perform a further beam alignment procedure.

The example apparatus may be further configured to: continue performing the opportunistic reception beam alignment procedure until the valid reception beam is determined.

The example apparatus may be further configured to: continue performing the opportunistic reception beam alignment procedure for a pre-configured time period.

Transmitting the indication that the valid reception beam is determined with respect to the first user equipment may comprise the example apparatus being configured to: transmit, to the first user equipment, an indication of at least one of: whether the valid reception beam is directed towards a wide beam or a narrow beam of the first user equipment, a beam of the first user equipment associated with the valid reception beam, a panel of the first user equipment associated with the valid reception beam, a time stamp associated with determination of the valid reception beam, a list of identifiers of beams or panels of the first user equipment used for the opportunistic reception beam alignment procedure, a list of a sidelink transmission configuration indicators used for the opportunistic reception beam alignment procedure, an indication of measurements associated with the beams or panels of the first user equipment used for the opportunistic reception beam alignment procedure, or received signal strength indicator associated with the beams or panels of first the user equipment used for the opportunistic reception beam alignment procedure.

The example apparatus may comprise a user equipment enabled to perform sidelink communication.

In accordance with one aspect, an example method may be provided comprising: determining, with a user equipment, to perform an opportunistic reception beam alignment procedure; receiving, from a first user equipment, an indication of a type of beamforming the first user equipment applies; determining to use at least one transmission of the first user equipment for the opportunistic reception beam alignment procedure based, at least partially, on one or more predefined conditions; performing the opportunistic reception beam alignment procedure based on at least part of a transmission of the first user equipment intended for, at least, at least one second user equipment; and transmitting, to the first user equipment, an indication that a valid reception beam is determined with respect to the first user equipment, wherein the valid reception beam may be determined as a result of the opportunistic reception beam alignment procedure.

Determining to perform the opportunistic reception beam alignment procedure may comprise: receiving a request to perform the opportunistic reception beam alignment procedure based on the transmission of the first user equipment intended for, at least, the at least one second user equipment.

The example method may further comprise: transmitting, in response to the received request, an indication of a determination to perform the opportunistic reception beam alignment procedure based on the transmission of the first user equipment intended for, at least, the at least one second user equipment.

Determining to perform the opportunistic reception beam alignment procedure may comprise: transmitting a request to perform the opportunistic reception beam alignment procedure.

The example method may further comprise: transmitting, to the first user equipment, at least one of: positioning assistance data, or quasi co-location information with the request to perform the opportunistic reception beam alignment procedure.

The example method may further comprise: receiving, in response to the transmitted request, a request to perform the opportunistic reception beam alignment procedure based on the transmission of the first user equipment intended for, at least, the at least one second user equipment.

The indication of the type of beamforming the first user equipment applies may be received as at least part of sidelink control information.

The indication of the type of beamforming the first user equipment applies may be received with at least one of: an indication of wide beam use, an indication of narrow beam use, an indication of at least one panel the first user equipment uses for transmission, an indication of at least one beam the first user equipment uses for transmission, an indication of beam identification the first user equipment uses for transmission, an indication of a sidelink transmission configuration indicator associated with the beam the first user equipment uses for transmission, an indication of a mobility the first user equipment is experiencing, or an indication of whether channel state information reference signal symbols are present in a current slot.

The one or more predefined conditions may comprise at least one of: presence of the at least one transmission of the first user equipment in a sidelink resource pool, presence of a unicast link with the first user equipment, a reference signal received power associated with the at least one transmission of the first user equipment is above a threshold value, which panel of the first user equipment uses for transmission, which beam the first user equipment uses for transmission, which identification beam the first user equipment uses for transmission, which sidelink transmission configuration indicator is associated with the beam the first user equipment uses for transmission, a current mobility of the first user equipment, a width of a beam of the at least one transmission of the first user equipment, a beam transmission identifier or sidelink transmission configuration indicator the first user equipment uses for transmission that has not yet been used by the user equipment in the opportunistic reception beam alignment procedure, presence, in a current slot, of channel state information reference signal symbols, previous communication of the user equipment with the first user equipment, the first user equipment transmitted a basic safety message or co-operative awareness message within a predetermined time period, or an indicated L1 priority of previous transmissions of the first user equipment is configured to indicate high priority traffic or high throughput traffic.

Performing the opportunistic beam alignment procedure may comprise: wherein the transmission of the first user equipment may comprise a second stage sidelink control information, wherein a slot comprising the second stage sidelink control information may further comprise at least one symbol, wherein the example method may further comprise using the at least one symbol in the slot for the opportunistic beam alignment procedure.

The at least one symbol may comprise at least one demodulation reference signal, wherein the example method may further comprise: performing receiver beam sweeping based on demodulation reference signal or channel state information reference signal sequence correlation.

The example method may further comprise: performing receiver beam sweeping based on energy detection.

Performing the opportunistic beam alignment procedure may comprise: wherein the transmission of the first user equipment may comprise a first stage sidelink control information, wherein the first stage sidelink control information may be configured to indicate further transmissions of the first user equipment, the example method may further comprise using at least one of the further transmissions of the first user equipment for the opportunistic beam alignment procedure.

The example method may further comprise: receiving an indication, from the first user equipment, to perform a further beam alignment procedure.

The example method may further comprise: continuing to perform the opportunistic reception beam alignment procedure until the valid reception beam is determined.

The example method may further comprise: continuing to perform the opportunistic reception beam alignment procedure for a pre-configured time period.

Transmitting the indication that the valid reception beam is determined with respect to the first user equipment may comprise: transmitting, to the first user equipment, an indication of at least one of: whether the valid reception beam is directed towards a wide beam or a narrow beam of the first user equipment, a beam of the first user equipment associated with the valid reception beam, a panel of the first user equipment associated with the valid reception beam, a time stamp associated with determination of the valid reception beam, a list of identifiers of beams or panels of the first user equipment used for the opportunistic reception beam alignment procedure, a list of sidelink transmission configuration indicators used for the opportunistic reception beam alignment procedure, an indication of measurements associated with the beams or panels of the first user equipment used for the opportunistic reception beam alignment procedure, or a received signal strength indicator associated with the beams or panels of the first user equipment used for the opportunistic reception beam alignment procedure.

The user equipment may comprise a user equipment enabled to perform sidelink communication.

In accordance with one example embodiment, an apparatus may comprise: circuitry configured to perform: determining to perform an opportunistic reception beam alignment procedure; circuitry configured to perform: receiving, from a first user equipment, an indication of a type of beamforming the first user equipment applies; circuitry configured to perform: determining to use at least one transmission of the first user equipment for the opportunistic reception beam alignment procedure based, at least partially, on or more predefined conditions; one circuitry configured to perform: performing the opportunistic reception beam alignment procedure based on at least part of a transmission of the first user equipment intended for, at least, at least one second user equipment; and circuitry configured to perform: transmitting, to the first user equipment, an indication that a valid reception beam is determined with respect to the first user equipment, wherein the valid reception beam may be determined as a result of the opportunistic reception beam alignment procedure.

In accordance with one example embodiment, an apparatus may comprise: processing circuitry; memory circuitry including computer program code, the memory circuitry and the computer program code configured to, with the processing circuitry, enable the apparatus to: determine to perform an opportunistic reception beam alignment procedure; receive, from a first user equipment, an indication of a type of beamforming the first user equipment applies; determine to use at least one transmission of the first user equipment for the opportunistic reception beam alignment procedure based, at least partially, on one or more predefined conditions; perform the opportunistic reception beam alignment procedure based on at least part of a transmission of the first user equipment intended for, at least, at least one second user equipment; and transmit, to the first user equipment, an indication that a valid reception beam is determined with respect to the first user equipment, wherein the valid reception beam may be determined as a result of the opportunistic reception beam alignment procedure.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and any (ii) portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: determining to perform an opportunistic reception beam alignment procedure; receiving, from a first user equipment, an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of a transmission of the first user equipment intended for, at least, at least one second user equipment; and transmitting, to the first user equipment, an indication that a valid reception beam is determined with respect to the first user equipment, wherein the valid reception beam may be determined as a result of the opportunistic reception beam alignment procedure.

The means configured to perform determining to perform the opportunistic reception beam alignment procedure may comprise means configured to perform: receiving a request to perform the opportunistic reception beam alignment procedure based on the transmission of the first user equipment intended for, at least, the at least one second user equipment.

The means may be further configured to perform: transmitting, in response to the received request, an indication of a determination to perform the opportunistic reception beam alignment procedure based on the transmission of the first user equipment intended for, at least, the at least one second user equipment.

The means configured to perform determining to perform the opportunistic reception beam alignment procedure may comprise means configured to perform: transmitting a request to perform the opportunistic reception beam alignment procedure.

The means may be further configured to perform: transmitting, to the first user equipment, at least one of: positioning assistance data, or quasi co-location information with the request to perform the opportunistic reception beam alignment procedure.

The means may be further configured to perform: receiving, in response to the transmitted request, a request to perform the opportunistic reception beam alignment procedure based on the transmission of the first user equipment intended for, at least, the at least one second user equipment.

The indication of the type of beamforming the first user equipment applies may be received as at least part of sidelink control information.

The indication of the type of beamforming the first user equipment applies may be received with at least one of: an indication of wide beam use, an indication of narrow beam use, an indication of at least one panel the first user equipment uses for transmission, an indication of at least one beam the first user equipment uses for transmission, an indication of beam identification the first user equipment uses for transmission, an indication of a sidelink transmission configuration indicator associated with the beam the first user equipment uses for transmission, an indication of a mobility the first user equipment is experiencing, or an indication of whether channel state information reference signal symbols are present in a current slot.

The one or more predefined conditions may comprise at least one of: presence of the at least one transmission of the first user equipment in a sidelink resource pool, presence of a unicast link with the first user equipment, a reference signal received power associated with the at least one transmission of the first user equipment is above a threshold value, which panel of the first user equipment uses for transmission, which beam the first user equipment uses for transmission, which beam identification the first user equipment uses for transmission, which sidelink transmission configuration indicator is associated with the beam the first user equipment uses for transmission, a current mobility of the first user equipment, a width of a beam of the at least one transmission of the first user equipment, a beam transmission identifier or sidelink transmission configuration indicator the first user equipment uses for transmission that has not yet been used by the apparatus in the opportunistic reception beam alignment procedure, presence, in a current slot, of channel state information reference signal symbols, previous communication of the apparatus with the first user equipment, the first user equipment transmitted a basic safety message or co-operative awareness message within a predetermined time period, or an indicated L1 priority of previous transmissions of the first user equipment is configured to indicate high priority traffic or high throughput traffic.

The means configured to perform causing performing of the opportunistic beam alignment procedure may comprise: wherein the transmission of the first user equipment may comprise a second stage sidelink control information, wherein a slot comprising the second stage sidelink control information may further comprise at least one symbol, means configured to perform using the at least one symbol in the slot for the opportunistic beam alignment procedure.

The at least one symbol may comprise at least one demodulation reference signal, wherein the means may be further configured to perform: causing performing of receiver beam sweeping based on demodulation reference signal or channel state information reference signal sequence correlation.

The means may be further configured to perform: causing performing of receiver beam sweeping based on energy detection.

The means configured to perform causing performing of the opportunistic beam alignment procedure may comprise: wherein the transmission of the first user equipment may comprise a first stage sidelink control information, wherein the first stage sidelink control information may be configured to indicate further transmissions of the first user equipment, means configured to perform using at least one of the further transmissions of the first user equipment for the opportunistic beam alignment procedure.

The means may be further configured to perform: receiving an indication, from the first user equipment, to perform a further beam alignment procedure.

The means may be further configured to perform: continuing performing of the opportunistic reception beam alignment procedure until the valid reception beam is determined.

The means may be further configured to perform: continuing performing of the opportunistic reception beam alignment procedure for a pre-configured time period.

The means configured to perform transmitting the indication that the valid reception beam is determined with respect to the first user equipment may comprise means configured to perform: transmitting, to the first user equipment, an indication of at least one of: whether the valid reception beam is directed towards a wide beam or a narrow beam of the first user equipment, a beam of the first user equipment associated with the valid reception beam, a panel of the first user equipment associated with the valid reception beam, a time stamp associated with determination of the valid reception beam, a list of identifiers of beams or panels of the first user equipment used for the opportunistic reception beam alignment procedure, a list of sidelink transmission configuration indicators used for the opportunistic reception beam alignment an indication procedure, of measurements associated with the beams or panels of the first user equipment used for the opportunistic reception beam alignment procedure, or a received signal strength indicator associated with the beams or panels of the first user equipment used for the opportunistic reception beam alignment procedure.

The apparatus may comprise a user equipment enabled to perform sidelink communication.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: determine to perform an opportunistic reception beam alignment procedure; receive, from a first user equipment, an indication of a type of beamforming the first user equipment applies; determine to use at least one transmission of the first user equipment for the opportunistic reception beam alignment procedure based, at least partially, on one or more predefined conditions; perform the opportunistic reception beam alignment procedure based on at least part of a transmission of the first user equipment intended for, at least, at least one second user equipment; and transmit, to the first user equipment, an indication that a valid reception beam is determined with respect to the first user equipment, wherein the valid reception beam may be determined as a result of the opportunistic reception beam alignment procedure.

In accordance with one example embodiment, a non-transitory computer-readable medium comprising program instructions stored thereon for performing at least the following: determining to perform an opportunistic reception beam alignment procedure; causing receiving, from a first user equipment, of an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of a transmission of the first user equipment intended for, at least, at least one second user equipment; and causing transmitting, to the first user equipment, of an indication that a valid reception beam is determined with respect to the first user equipment, wherein the valid reception beam may be determined as a result of the opportunistic reception beam alignment procedure.

In accordance with another example embodiment, a non-transitory program storage device readable by a machine may be provided, tangibly embodying instructions executable by the machine for performing operations, the operations comprising: determining to perform an opportunistic reception beam alignment procedure; causing receiving, from a first user equipment, of an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of a transmission of the first user equipment intended for, at least, at least one second user equipment; and causing transmitting, to the first user equipment, of an indication that a valid reception beam is determined with respect to the first user equipment, wherein the valid reception beam may be determined as a result of the opportunistic reception beam alignment procedure.

In accordance with another example embodiment, a non-transitory computer-readable medium comprising instructions that, when executed by an apparatus, cause the apparatus to perform at least the following: determining to perform an opportunistic reception beam alignment procedure; causing receiving, from a first user equipment, of an indication of a type of beamforming the first equipment applies; user determining to use at least one transmission of the first user equipment for the opportunistic reception beam alignment procedure based, at least partially, on one or more predefined conditions; causing performing of the opportunistic reception beam alignment procedure based on at least part of a transmission of the first user intended for, at least, at least one second user equipment; and causing transmitting, to the first user equipment, of an indication that a valid reception beam is determined with respect to the first user equipment, wherein the valid reception beam may be determined as a result of the opportunistic reception beam alignment procedure.

A computer implemented system comprising: at least one processor and at least one non-transitory memory storing instructions that, when executed by the at least one processor, cause the system at least to perform: determining to perform an opportunistic reception beam alignment procedure; causing receiving, from a first user equipment, of an indication of a type of beamforming the first user equipment applies; determining to use at least one transmission of the first user equipment for the opportunistic reception beam alignment procedure based, at least partially, on one or more predefined conditions; causing performing of the opportunistic reception beam alignment procedure based on at least part of transmission of the first user equipment intended for, at least, at least one second user equipment; and causing transmitting, to the first user equipment, of an indication that a valid reception beam is determined with respect to the first user equipment, wherein the valid reception beam may be determined as a result of the opportunistic reception beam alignment procedure.

A computer implemented system comprising: means for determining to perform an opportunistic reception beam alignment procedure; means for causing receiving, from a first user equipment, of an indication of a type of beamforming the first user equipment applies; means for determining to use at least one transmission of the first user equipment for the opportunistic reception beam alignment procedure based, at least partially, on one or more predefined conditions; means for causing performing of the opportunistic reception beam alignment procedure based on at least part of a transmission of the first user equipment intended for, at least, at least one second user equipment; and means for causing transmitting, to the first user equipment, of an indication that a valid reception beam is determined with respect to the first user equipment, wherein the valid reception beam may be determined as a result of the opportunistic reception beam alignment procedure.

In accordance with one example embodiment, an apparatus may comprise: at least one processor; and at least one memory storing instructions that, when executed by the at least one processor, cause the apparatus at least to: determine to perform an opportunistic reception beam alignment procedure; transmit, to a first user equipment, an indication of a type of beamforming; transmit, to the first user equipment, at least one transmission based on the indicated type of beamforming; and receive, from the first user equipment, an indication of a valid reception beam determined as a result of the opportunistic reception beam alignment procedure.

Determining to perform the opportunistic reception beam alignment procedure may comprise the example apparatus being configured to: receive, from the first user equipment, a request to perform the opportunistic reception beam alignment procedure; and determine to perform the opportunistic reception beam alignment procedure based, at least partially, on the received request.

The received request to perform the opportunistic reception beam alignment procedure may further comprise at least one of: positioning assistance data, or quasi co-location information.

The example apparatus may be further configured to: transmit, to the first user equipment, a request to perform the opportunistic reception beam alignment procedure.

The indication of the type of beamforming may be transmitted as at least part of sidelink control information.

The indication of the type of beamforming may further comprise least one of: an indication of wide beam use, an indication of narrow beam use, an indication of at least one panel the apparatus for transmission, an indication of at least one beam the apparatus uses for transmission, an indication of beam identification the apparatus uses for transmission, an indication of a sidelink transmission configuration indicator the apparatus uses for transmission, an indication of a mobility the apparatus is experiencing, or an indication of whether channel state information reference signal symbols are present in a current slot.

The example apparatus may be further configured to: transmit, to the first user equipment, an indication to perform a further beam alignment procedure.

The received indication of the valid reception beam may comprise an indication of at least one of: whether the valid reception beam is directed towards a wide beam or a narrow beam of the apparatus, beam of the apparatus associated with the valid reception beam, a panel of the apparatus associated with the valid reception beam, a time stamp associated with determination of the valid reception beam, a list of identifiers of beams or panels of the apparatus used for the opportunistic reception beam alignment procedure, a list of sidelink transmission configuration indicators used for the opportunistic reception beam alignment procedure, an indication of measurements associated with the beams or panels of the apparatus used for the opportunistic reception beam alignment procedure, or a received signal strength indicator associated with the beams or panels of the apparatus used for the opportunistic reception beam alignment procedure.

In accordance with one aspect, an example method may be provided comprising: determining, with a user equipment, to perform an opportunistic reception beam alignment procedure; transmitting, to a first user equipment, an indication of a type of beamforming; transmitting, to the first user equipment, at least one transmission based on the indicated type of beamforming; and receiving, from the first user equipment, an indication of a valid reception beam determined as a result of the opportunistic reception beam alignment procedure.

Determining to perform the opportunistic reception beam alignment procedure may comprises: receiving, from the first user equipment, a request to perform the opportunistic reception beam alignment procedure; and determining to perform the opportunistic reception beam alignment procedure based, at least partially, on the received request.

The received request to perform the opportunistic reception beam alignment procedure may further comprise at least one of: positioning assistance data, or quasi co-location information.

The example method may further comprise: transmitting, to the first user equipment, a request to perform the opportunistic reception beam alignment procedure.

The indication of the type of beamforming may be transmitted as at least part of sidelink control information.

The indication of the type of beamforming may further comprise at least one of: an indication of wide beam use, an indication of narrow beam use, an indication of at least one panel the user equipment uses for transmission, an indication of at least one beam the user equipment uses for transmission, an indication of beam identification the user equipment uses for transmission, an indication of a sidelink transmission configuration indicator user for the equipment uses transmission, an indication of a mobility the user equipment is experiencing, or an indication of whether channel state information reference signal symbols are present in a current slot.

The example method may further comprise: transmitting, to the first user equipment, an indication to perform a further beam alignment procedure.

The received indication of the valid reception beam may comprise an indication of at least one of: whether the valid reception beam is directed towards a wide beam or a narrow beam of the user equipment, a beam of the user equipment associated with the valid reception beam, a panel of the user equipment associated with the valid reception beam, a time stamp associated with determination of the valid reception beam, a list of identifiers of beams or panels of the user equipment used for the opportunistic reception beam alignment procedure, a list of sidelink transmission configuration indicators used for the opportunistic reception beam alignment procedure, an indication of measurements associated with the beams or panels of the user equipment used for the opportunistic reception beam alignment procedure, or a received signal strength indicator associated with the beams or panels of the user equipment used for the opportunistic reception beam alignment procedure.

In accordance with one example embodiment, an apparatus may comprise: circuitry configured to perform: determining, with a user equipment, to perform an opportunistic reception beam alignment procedure; circuitry configured to perform: transmitting, to a first user equipment, an indication of a type of beamforming; circuitry configured to perform: transmitting, to the first user equipment, at least one transmission based on the indicated type of beamforming; and circuitry configured to perform: receiving, from the first user equipment, an indication of a valid reception beam determined as a result of the opportunistic reception beam alignment procedure.

In accordance with one example embodiment, an apparatus may comprise: processing circuitry; memory circuitry including computer program code, the memory circuitry and the computer program code configured to, with the processing circuitry, enable the apparatus to: determine to perform an opportunistic reception beam alignment procedure; transmit, to a first user equipment, an indication of a type of beamforming; transmit, to the first user equipment, at least one transmission based on the indicated type of beamforming; and receive, from the first user equipment, an indication of a valid reception beam determined as a result of the opportunistic reception beam alignment procedure.

In accordance with one example embodiment, an apparatus may comprise means for performing: determining to perform an opportunistic reception beam alignment procedure; transmitting, to a first user equipment, an indication of a type of beamforming; transmitting, to the first user equipment, at least one transmission based on the indicated type of beamforming; and receiving, from the first user equipment, an indication of a valid reception beam determined as a result of the opportunistic reception beam alignment procedure.

The means configured to perform determining to perform the opportunistic reception beam alignment procedure may comprise means configured to perform: receiving, from the first user equipment, a request to perform the opportunistic reception beam alignment procedure; and determining to perform the opportunistic reception beam alignment procedure based, at least partially, on the received request.

The received request to perform the opportunistic reception beam alignment procedure may further comprise at least one of: positioning assistance data, or quasi co-location information.

The means may be further configured to perform: transmitting, to the first user equipment, a request to perform the opportunistic reception beam alignment procedure.

The indication of the type of beamforming may be transmitted as at least part of sidelink control information.

The indication of the type of beamforming may further comprise least one of: an indication of wide beam use, an indication of narrow beam use, an indication of at least one panel the apparatus uses for transmission, an indication of at least one beam the apparatus uses for transmission, an indication of beam identification the apparatus uses for transmission, an indication a of sidelink transmission configuration indicator the apparatus uses for transmission, an indication of a mobility the apparatus is experiencing, or an indication of whether channel state information reference signal symbols are present in a current slot.

The means may be further configured to perform: transmitting, to the first user equipment, an indication to perform a further beam alignment procedure.

The received indication of the valid reception beam may comprise an indication of at least one of: whether the valid reception beam is directed towards a wide beam or a narrow beam of the apparatus, a beam of the apparatus associated with the valid reception beam, panel of the apparatus associated with the valid reception beam, a time stamp associated with determination of the valid reception beam, a list of identifiers of beams or panels of the apparatus used for the opportunistic reception beam alignment procedure, a list of sidelink transmission configuration indicators used for the opportunistic reception beam alignment procedure, an indication of measurements associated with the beams or panels of the apparatus used for the opportunistic reception beam alignment procedure, or a received signal strength indicator associated with the beams or panels of the apparatus used for the opportunistic reception beam alignment procedure.

In accordance with one example embodiment, a non-transitory computer-readable medium comprising instructions stored thereon which, when executed with at least one processor, cause the at least one processor to: determine to perform an opportunistic reception beam alignment procedure; transmit, to a first user equipment, an indication of a type of beamforming; transmit, to the first equipment, at least one transmission based on the indicated type of beamforming; and receive, from the first user equipment, an indication of a valid reception beam determined as a result of the opportunistic reception beam alignment procedure.

In accordance with one example embodiment, a non-transitory computer-readable medium comprising program instructions stored thereon for performing at least the following: determining to perform an opportunistic reception beam alignment causing transmitting, to a first user equipment, of an indication of a type of beamforming; causing transmitting, to the first user equipment, of at least one transmission based on the indicated type of beamforming; and causing receiving, from the first user equipment, of an indication of a valid reception beam determined as a result of the opportunistic reception beam alignment procedure.

In accordance with another example embodiment, a non-transitory program storage device readable by a machine may be provided, tangibly embodying instructions executable by the machine for performing operations, the operations comprising: determining to perform an opportunistic reception beam alignment procedure; causing transmitting, to a first user equipment, of an indication of a type of beamforming; causing transmitting, to the first user equipment, of at least one transmission based on the indicated type of beamforming; and causing receiving, from the first user equipment, of an indication of a valid reception beam determined as a result of the opportunistic reception beam alignment procedure.

In accordance with another example embodiment, a non-transitory computer-readable medium comprising instructions that, when executed by an apparatus, cause the apparatus to perform at least the following: determining to perform an opportunistic reception beam alignment procedure; causing transmitting, to a first user equipment, of an indication of a type of beamforming; causing transmitting, to the first user equipment, of at least one transmission based on the indicated type of beamforming; and causing receiving, from the first user equipment, of an indication of a valid reception beam determined as a result of the opportunistic reception beam alignment procedure.

A computer implemented system comprising: at least one processor and at least one non-transitory memory storing instructions that, when executed by the at least one processor, cause the system at least to perform: determining to perform an opportunistic reception beam alignment procedure; causing transmitting, to a first user equipment, of an indication of a type of beamforming; causing transmitting, to the first user equipment, of at least one transmission based on the indicated type of beamforming; and causing receiving, from the first user equipment, of an indication of a valid reception beam determined as a result of the opportunistic reception beam alignment procedure.

A computer implemented system comprising: means for determining to perform an opportunistic reception beam alignment procedure; means causing transmitting, to a first user equipment, of an indication of a type of beamforming; means for causing transmitting, to the first user equipment, of at least one transmission based on the indicated type of beamforming; and means for causing receiving, from the first user equipment, of an indication of a valid reception beam determined as a result of the opportunistic reception beam alignment procedure.

The term “non-transitory,” as used herein, is a limitation of the medium itself (i.e. tangible, not a signal) as opposed to a limitation on data storage persistency (e.g., RAM VS. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one non-transitory memory storing instructions that, when executed by the at least one processor, cause the apparatus at least to:
determine to perform an opportunistic reception beam alignment procedure;
receive, from a first user equipment, an indication of a type of beamforming the first user equipment applies;
determine to use at least one transmission of the first user equipment for the opportunistic reception beam alignment procedure based, at least partially, on one or more predefined conditions;
perform the opportunistic reception beam alignment procedure based on at least part of a transmission of the first user equipment intended for, at least, at least one second user equipment; and
transmit, to the first user equipment, an indication that a valid reception beam is determined with respect to the first user equipment, wherein the valid reception beam is determined as a result of the opportunistic reception beam alignment procedure.

2. The apparatus of claim 1, wherein determining to perform the opportunistic reception beam alignment procedure comprises the at least one memory, storing the instructions, when executed by the at least one processor, causes the apparatus to:
receive a request to perform the opportunistic reception beam alignment procedure based on the transmission of the first user equipment intended for, at least, the at least one second user equipment.

3. The apparatus of claim 2, wherein the at least one memory, storing the instructions, when executed by the at least one processor, causes the apparatus to:
transmit, in response to the received request, an indication of a determination to perform the opportunistic reception beam alignment procedure based on the transmission of the first user equipment intended for, at least, the at least one second user equipment.

4. The apparatus of claim 1, wherein determining to perform the opportunistic reception beam alignment procedure comprises the at least one memory, storing the instructions, when executed by the at least one processor, causes the apparatus to:
transmit a request to perform the opportunistic reception beam alignment procedure.

5. The apparatus of claim 4, wherein the at least one memory, storing the instructions, when executed by the at least one processor, causes the apparatus to:
transmit, to the first user equipment, at least one of: positioning assistance data, or quasi co-location information with the request to perform the opportunistic reception beam alignment procedure.

6. The apparatus of claim 4, wherein the at least one memory, storing the instructions, when executed by the at least one processor, causes the apparatus to:
receive, in response to the transmitted request, a request to perform the opportunistic reception beam alignment procedure based on the transmission of the first user equipment intended for, at least, the at least one second user equipment.

7. The apparatus of claim 1, wherein the indication of the type of beamforming the first user equipment applies is received as at least part of sidelink control information.

8. The apparatus of claim 1, wherein the indication of the type of beamforming the first user equipment applies is received with at least one of:
an indication of wide beam use,
an indication of narrow beam use,
an indication of at least one panel the first user equipment uses for transmission,
an indication of at least one beam the first user equipment uses for transmission,
an indication of beam identification the first user equipment uses for transmission,
an indication of a sidelink transmission configuration indicator associated with the beam the first user equipment uses for transmission,
an indication of a mobility the first user equipment is experiencing, or
an indication of whether channel state information reference signal symbols are present in a current slot.

9. The apparatus of claim 1, wherein the one or more predefined conditions comprise at least one of:
presence of the at least one transmission of the first user equipment in a sidelink resource pool,
presence of a unicast link with the first user equipment,
a reference signal received power associated with the at least one transmission of the first user equipment is above a threshold value,
which panel of the first user equipment uses for transmission,
which beam the first user equipment uses for transmission,
which beam identification the first user equipment uses for transmission,
which sidelink transmission configuration indicator is associated with the beam the first user equipment uses for transmission,
a current mobility of the first user equipment,
a width of a beam of the at least one transmission of the first user equipment, a beam transmission identifier or sidelink transmission configuration indicator the first user equipment uses for transmission that has not yet been used by the apparatus in the opportunistic reception beam alignment procedure,
presence, in a current slot, of channel state information reference signal symbols,
previous communication of the apparatus with the first user equipment,
the first user equipment transmitted a basic safety message or co-operative awareness message within a predetermined time period, or
an indicated L1 priority of previous transmissions of the first user equipment is configured to indicate high priority traffic or high throughput traffic.

10. The apparatus of claim 1, wherein performing the opportunistic beam alignment procedure comprises the at least one memory, storing the instructions, when executed by the at least one processor, causes the apparatus to:
wherein the transmission of the first user equipment comprises a second stage sidelink control information, wherein a slot comprising the second stage sidelink control information further comprises at least one symbol, use the at least one symbol in the slot for the opportunistic beam alignment procedure.

11. The apparatus of claim 10, wherein the at least one symbol comprises at least one demodulation reference signal, wherein the at least one memory, storing the instructions, when executed by the at least one processor, causes the apparatus to:
perform receiver beam sweeping based on demodulation reference signal or channel state information reference signal sequence correlation.

12. The apparatus of claim 10, wherein the at least one memory, storing the instructions, when executed by the at least one processor, causes the apparatus to:
perform receiver beam sweeping based on energy detection.

13. The apparatus of claim 1, wherein performing the opportunistic beam alignment procedure comprises the at least one memory, storing the instructions, when executed by the at least one processor, causes the apparatus to:
wherein the transmission of the first user equipment comprises a first stage sidelink control information, wherein the first stage sidelink control information is configured to indicate further transmissions of the first user equipment, use at least one of the further transmissions of the first user equipment for the opportunistic beam alignment procedure.

14. The apparatus of claim 1, wherein the at least one memory, storing the instructions, when executed by the at least one processor, causes the apparatus to:
receive an indication, from the first user equipment, to perform a further beam alignment procedure.

15. The apparatus of claim 1, wherein the at least one memory, storing the instructions, when executed by the at least one processor, causes the apparatus to:
continue performing the opportunistic reception beam alignment procedure until the valid reception beam is determined.

16. The apparatus of claim 1, wherein the at least one memory, storing the instructions, when executed by the at least one processor, causes the apparatus to:
continue performing the opportunistic reception beam alignment procedure for a pre-configured time period.

17. The apparatus of claim 1, wherein transmitting the indication that the valid reception beam is determined with respect to the first user equipment comprises the at least one memory, storing the instructions, when executed by the at least one processor, causes the apparatus to:
transmit, to the first user equipment, an indication of at least one of:
whether the valid reception beam is directed towards a wide beam or a narrow beam of the first user equipment,
a beam of the first user equipment associated with the valid reception beam,
a panel of the first user equipment associated with the valid reception beam,
a time stamp associated with determination of the valid reception beam,
a list of identifiers of beams or panels of the first user equipment used for the opportunistic reception beam alignment procedure,
a list of sidelink transmission configuration indicators used for the opportunistic reception beam alignment procedure,
an indication of measurements associated with the beams or panels of the first user equipment used for the opportunistic reception beam alignment procedure, or
a received signal strength indicator associated with the beams or panels of the first user equipment used for the opportunistic reception beam alignment procedure.

18. The apparatus of claim 1, wherein the apparatus comprises a user equipment enabled to perform sidelink communication.

19. A method comprising:
determining, with a user equipment, to perform an opportunistic reception beam alignment procedure;
receiving, from a first user equipment, an indication of a type of beamforming the first user equipment applies;
determining to use at least one transmission of the first user equipment for the opportunistic reception beam alignment procedure based, at least partially, on one or more predefined conditions;
performing the opportunistic reception beam alignment procedure based on at least part of a transmission of the first user equipment intended for, at least, at least one second user equipment; and
transmitting, to the first user equipment, an indication that a valid reception beam is determined with respect to the first user equipment, wherein the valid reception beam is determined as a result of the opportunistic reception beam alignment procedure.

20-39. (canceled)

40. An apparatus comprising:
at least one processor; and
at least one non-transitory memory storing instructions that, when executed by the at least one processor, cause the apparatus at least to:
determine to perform an opportunistic reception beam alignment procedure;
transmit, to a first user equipment, an indication of a type of beamforming;
transmit, to the first user equipment, at least one transmission based on the indicated type of beamforming; and
receive, from the first user equipment, an indication of a valid reception beam determined as a result of the opportunistic reception beam alignment procedure.

41-50. (canceled)
